(19) United States
(12) Patent Application Publication
(10) Pub. No.: US 2013/0133000 A1
(43) Pub. Date: May 23, 2013

(54) Video Interaction System

(71) Applicant: Christopher Lee Kelley, Sacramento, CA (US)

(72) Inventor: Christopher Lee Kelley, Sacramento, CA (US)

(21) Appl. No.: 13/680,339

(22) Filed: Nov. 19, 2012

Related U.S. Application Data
(60) Provisional application No. 61/561,892, filed on Nov. 20, 2011.

(51) Int. Cl. H04N 21/482

(52) U.S. Cl. CPC H04N 21/482
USPC 725/37

(57) ABSTRACT

Apparatus and methods are described that allow content associated with specified passages of a video program to be retrieved from a network and presented to the viewer of the video program in synchronization with the identified passages. A video waymark host that may be located in a television monitor or attached equipment such as a set-top box is disclosed. The waymark host identifies the occurrence of various points as the video is viewed and communicates this information to connected viewing devices such computers or mobile phones, allowing for the synchronized presentation of content on these devices.

### BACKGROUND OF THE INVENTION

1. Field of the Invention

The present invention relates to systems for identifying specific points within the presentation of a video program that permit users to share information and electronic content linked to specific locations within that video program.

2. Discussion

Traditionally television has been a one-way medium. While various efforts have been made to introduce interactive content, generally the interaction opportunities were limited to selecting from a short menu of choices that did not give users the opportunity to express original or creative thought about what they were seeing. The ability of viewers to communicate meaningfully back “up” the cable to the programmer or “across” to other viewers was limited and the messages that could be sent were usually inauthentic and uninteresting. As a result interactive TV applications have not given viewers the ability to communicate meaningfully with friends or other viewers about the content that they are watching.

There is, nevertheless, a great interest among television viewers in reacting to and commenting on what they watch. Online communities where viewers can share commentary about television programming are popular and it is quite common for blogs and news outlets to offer liveblogging of televised events such as political debates or sports contests to which viewers can append their own commentary about the televised event.

One of the challenges associated with video programming is that video is distributed as a series of frames that are not authoritatively indexed. The same video program can be encoded into many different digital representations and can be presented at different frame rates and picture resolutions. Television programs may be presented at different times in different time zones across the nation and with the advent of video recording, viewers no longer necessarily watch programming at the same time as they receive it. When they do sit down to view a program, they may not view it linearly. They can pause the recording or skip forward and backward.

The fact that viewers are all watching the program at different times makes supporting interactions among users more difficult. At least one company has developed a platform that allows viewers to share commentary about a video program, but requires them to watch the program at the same time. The requirement that all participants must view the program at the same time limits the appeal of this platform. The fact that all interaction between users must occur in real time during video playback also limits the quality of the interactions as there is no opportunity to prepare thoughtful or detailed commentary.

It would be advantageous to provide a system that allows users to identify specific locations within a video program and to associate commentary and content with those playback locations. When other users viewed those points in the video program they should be able to access that commentary and content. The system should allow users to watch the video program at different times but still receive whatever commentary other users had previously associated with that program. In addition, the system should allow users to exchange commentary and interaction during live programming, since live events like sporting events are often the occasions when viewers are most engaged and interested in virtual interactions with each other.

### SUMMARY OF THE INVENTION

The invented TV interaction system implements a method and apparatus that allows user-generated content to be associated with specific sets of frame images contained in a longer video sequence, such as a television program or a movie. The system includes a video waymark host that may be located in a television set or in external equipment connected to the television set. This external equipment can be, for example, a set-top box that decodes and presents video content received from a cable service or the internet. The video waymark host could also be located in a disc player such as Blu-Ray or DVD disk player or similar device that can source video programming.

The video waymark host can transmit information identifying the video program and a stream of waymarks that identify specific points in the video program as these are presented to the user on their television. Computing devices such as a tablet computer, a smartphone or a laptop can communicate with the video waymark host and obtain access to the stream of waymarks that the host generates. An invented application program interface layer on these computing devices is described that communicates with the video waymark host and provides video program identification information, video playback status information and waymark information to application programs in the computing device. These applications can then use this information to identify and retrieve content on network hosts that is associated with the video program. The invented system allows this network content to be associated with specific passages of the viewed video. The application programs on the computing devices can use the waymark information to determine when a specific passage of video is displayed on the television and can then present the content associated with that part of the program to the user so that it will be synchronized with what the user is watching.

In one embodiment, when the video waymark host receives video programming it may also receive waymark references that associate waymarks with specific frames within the video. The video waymark host uses this information to identify to the user that the specified waymark has been reached when the corresponding frame is displayed.

In another embodiment, the video waymark host may receive waymark tracking information that identifies distinctive properties of specific video frames in the sequence of video programming that is being presented on the television. The waymark tracking information received by the video waymark host also identifies how specific waymarks are related to the frames having these specific properties, or metrics. The video waymark host generates similar metrics from the video programming that is presented on the television. The host then matches the metrics that it has calculated with those identified in the waymark tracking information that it has received. Once a reliable match has been identified, the video waymark host can establish a correspondence between the frames that it used to generate the matching metrics and the waymarks that were identified in the waymark tracking information. In this manner the video waymark host can determine when waymarks are reached as the video is presented. This information can then be conveyed to the application program interface layer on the computing devices. Algorithms for matching calculated metrics to received metrics are described.

In order to conduct an exchange of waymark information between the video waymark host and the separate computing device, protocols and data structures for the exchange of video programming information, playback status or waymark information may be required. This application describes one set of protocols and data structures for carrying out the exchange of waymark information between a network host and the waymark host and between the waymark host and computing devices that may use these waymarks to display content synchronized to the video program on the user's television.

The functions performed by the video waymark host are closely related to the video processing functions already included in a modern set-top box or a television monitor able to receive digital video streams. This application describes how a video waymark host may be implemented on a typical modern set-top box or television using the existing processing and storage elements found in that device without requiring major modifications to its design.

### BRIEF DESCRIPTION OF THE DRAWINGS

FIG. 1 is an illustration of an arrangement, in accordance with one embodiment of the invention, of various network and video elements that may be used to enable the user of a computing device to access network content associated with passages of a video program that the user may be viewing on their television.

FIG. 2. is an illustration of a hierarchy of software modules that may be used to support presentation of network content associated with video programming in one embodiment of the invention.

FIG. 3 is an illustration of how social network data might be organized on a social networking server in order to support content associated with video programming in one embodiment of the invention.

FIG. 4 is a block diagram of the elements of a set-top box that implements support for video program tracking in accordance with one embodiment of the invention.

FIG. 5 is an illustration of elements of a video tracking host resident on a set-top box in accordance with one embodiment of the invention.

FIG. 6 is an illustration of data flows that may be exchanged between the elements of the invented system in accordance with one embodiment of the invention.

FIG. 7 is a depiction of a notification panel for a tablet device illustrating example notifications that might be generated by applications that present content based on current video programming in accordance with one embodiment of the invention.

FIG. 8 is a depiction of a tablet and television monitor in an example usage of the invented system where the tablet displays content associated with passages of the video program displayed on the television monitor.

FIG. 9 is a drawing illustrating the temporal relationship between data structures used for identifying reference waymarks for a video program in accordance with one embodiment of the invention.

FIG. 10 is an illustration of an alternative arrangement of various system elements that permit presentation of content associated with passages of video programming in accordance with one embodiment of the invention.

### DETAILED DESCRIPTION OF THE INVENTION

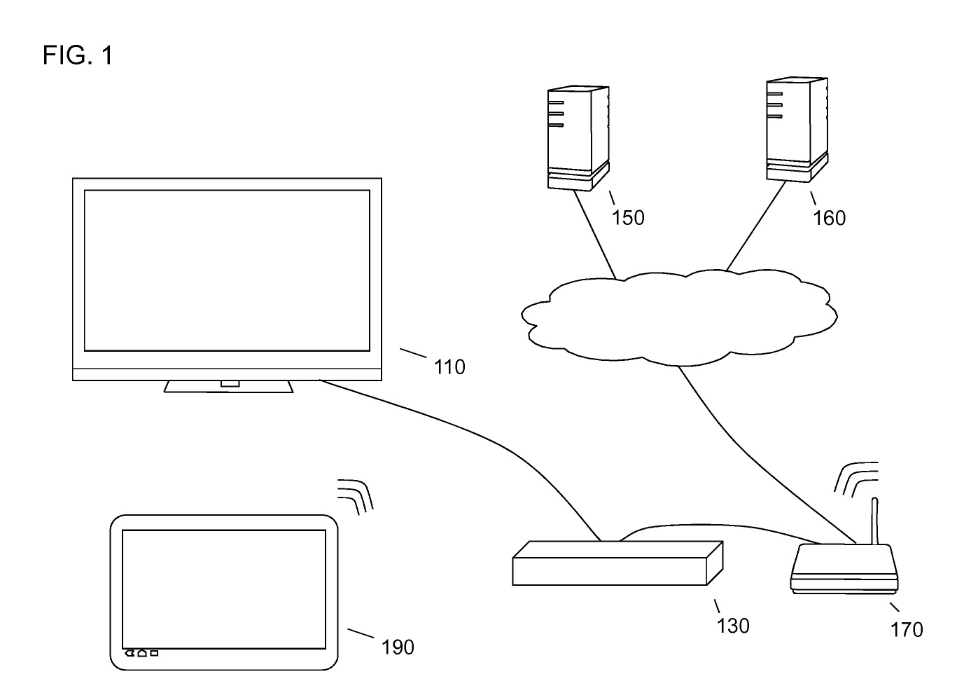

With reference to FIG. 1, the various elements that may be used in presentation of content linked to video playback in accordance with one embodiment of the invention are depicted. In FIG. 1, video monitor 110 is connected to set-top box 130 by way of a standardized interface, such as High-Definition Multimedia Interface (HDMI), Digital Visual Interface (DVI) or analog interfaces such as composite video. The set-top box 130 is connected to network router 170. Network router 170 provides communication with a wide area network (WAN), one example of which is the internet. In FIG. 1 the network router 170 is also shown as providing the infrastructure for a wireless network interface using protocols such as the IEEE 802.11 WiFi protocols. In other embodiments the provision of wired and wireless network connections can be done by two physically separate, but connected, devices.

Set-top box 130 may receive video programming content from programming sources connected to the internet, which are not shown in FIG. 1. The video programming from these sources can be transferred to the set-top box 130 through network router 170. Alternatively set-top box 130 may receive video programming using a tuner from over the air sources such as traditional terrestrial or satellite broadcast or from wired sources such as a cable system. The connection of set-top box 130 to these other sources of video programming is not illustrated in FIG. 1.

Tablet 190 is a portable device that includes a display and processor and can run applications, present video and audio, and display html files or documents in standard formats such as the Microsoft Word (.DOC) format and the Adobe Portable Data Format (.PDF). In one embodiment of the invention, tablet 190 includes support for a wireless network interface such as IEEE 802.11 suitable for connecting to a local area network (LAN) and may also include support for wireless network interfaces supporting connections to wireless WANs operated by wireless infrastructure companies such as 3G and 4G wireless network operators.

Collectively the video monitor 110, the network router 170, the set-top box 130 and tablet 190 constitute a LAN. Any of the devices may connect to this network with a wired connection to network router 170 or they may connect wirelessly to a wireless access point connected to the network, like that shown in FIG. 1 as part of network router 170.

TV track server 150 is connected to the internet or other public network, which is represented in FIG. 1 as a cloud. As described in greater detail herein, TV track server 150 may provide video tracking information to the set-top box 130, video monitor 110 or other devices in the LAN. The video tracking information supplied by TV track server 150 may be used to identify and track a program playing on video monitor 110.

Content server 160 is also connected to the internet or public WAN, and through that to the elements in the LAN. Content server 160 supplies content to tablet 190 that is coordinated with the playback of video on the video monitor 110. As described in greater detail herein, content server 160 could be part of a social networking service, or it could be a network host affiliated with a television network that supplies content generated or sponsored by the same commercial enterprise that sourced the video programming. Alternatively, content server 160 could be a third-party network host that operates independently and hosts content generated by the public or other individuals who may operate independently of the production of the underlying video program.

While set-top box 130 and monitor 110 are separately identified and illustrated in FIG. 1 as separate devices, it will be understood by a person of ordinary skill in the art that the functions of monitor 110 and set-top 130 can be integrated in a single physical device without impacting the functional behavior of either device. It will also be understood that while tablet 190 is identified as a tablet computer, the functions implemented on tablet 190 could also be implemented on other computing devices such as a laptop computer, a smartphone or any other electronic device that includes processing and display capabilities.

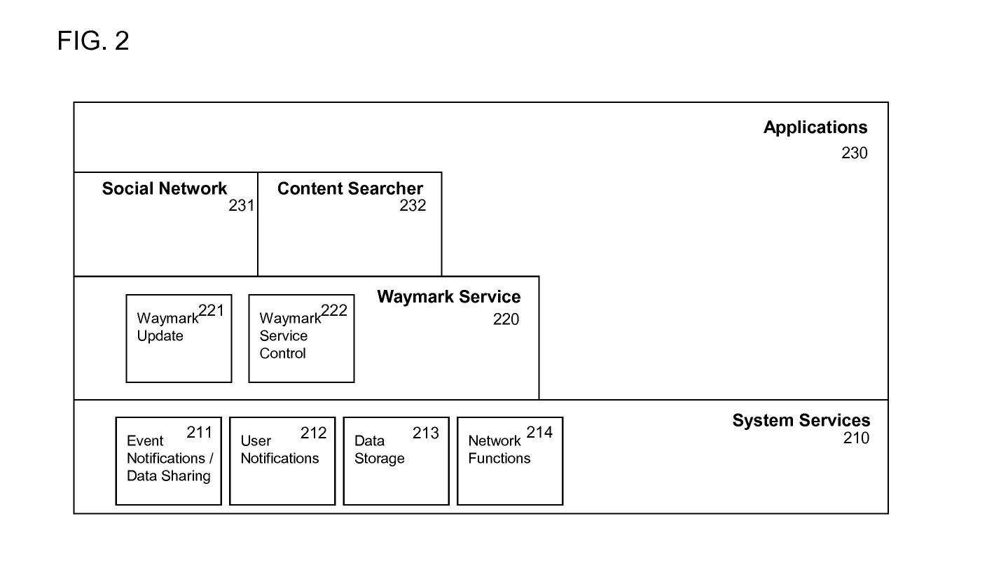

With reference to FIG. 2, the high-level relationship of some of the software modules that operate on table 190 and that play a role in provision of the TV track service is illustrated. Tablet 190 includes an operating system that provides a set of system services 210 that may be used by applications running on the tablet. Current model tablet computers may run operating systems such as the Android OS, Windows, or Apple's iOS. The system services 210 provided by the operating system include event notification and data sharing functions 211, user notification functions 212, data storage 213 and network functions 214. The event notification and data sharing functions 211 allow data to be shared between multiple applications. These functions notify applications that have access to specific data when that data has been modified. This provides one method by which applications on tablet 190 can coordinate their activities. One example of a set of event notification and data sharing functions is the content provider API included in the Android operating system developed by Google.

The user notification functions 212 permit applications to provide notifications to the user of tablet 190 regarding the occurrence of some event. Typical operating systems deployed on a tablet or mobile phone device provide user notifications of events arising from operation of applications running on the platform. These notifications can identify things such as the arrival of an e-mail, a missed phone call, and the like. The presence of pending user notifications is typically identified visually on the main screen of the operating system in a manner that alerts the user of the tablet 190 to the fact that there are notifications that may be reviewed. If the user elects to review the notifications the operating system may provide greater detail about the nature of the notified event. The user may also be able to launch or invoke the application that generated the notification.

Data storage functions 213 provide access to the non-volatile data storage on the tablet 190. Network functions 214 allow applications to access the local area network by using the network capabilities of tablet 190. Tablet 190 can access the internet through a network device in the LAN such as router 170 that is capable of routing packets from tablet 190 to the internet. Alternatively, tablet 190 may be able to access the internet by way of a modem in tablet 190 that connects to a commercial wide area data network such as the 3G and 4G networks offered by the wireless service providers, or through a wired connection. A typical smartphone or tablet operating system will provide additional system services in addition to those discussed here.

Tablet 190 also hosts software that implements waymark service 220. Waymark service 220 may utilize the system services 210 provided by the operating system. The waymark service 220 includes a waymark update service 221. The waymark services 220 can be used by higher level applications 230 such as social network application 231 and content searcher 232. The waymark update service 221 can provide a stream of data to higher layer applications 230 that identifies the video program playing on monitor 110 and the current presentation position within that program. In addition, waymark update service 221 can provide immediate updates whenever there is a change in the video program or in the playback mode or when the playback location changes abruptly and in a manner that is inconsistent with the video program advancing at a normal rate of playback. Alternatively, the higher layer applications 230 may also query the waymark update service update service 221 for reports about the current status of TV playback. In alternative embodiments of the invention, the communication of current TV playback location information can be “pushed” from the waymark update service 221, “pulled” by polling from the applications 230 or some mix of these activities.

Waymark service 220 also includes waymark service control 222. Waymark service control 222 controls the operation of waymark service 220 and communicates with set-top box 130 as described herein in greater detail. In some embodiments of the invention, waymark service control 222 may also communicate with content server 160.

With reference to FIG. 2, higher level applications 230 such as social network application 231 and content searcher 232 are illustrated as examples of possible users of the interfaces provided by the TV track services 220.

Social network application 231 permits the user of tablet 190 to interact with social network content on a server such as content server 160. In a typical social network, users may access data hosted on content server 160 that was generated by other users who allow access to this content to their friends or social acquaintances. While the content posted to social networks traditionally has involved text, images or video, the TV interaction system allows users of social networks to post content that is associated with a particular video program. When a user of the TV interaction system views a video program, the social network application 231 on the user's tablet 190 can inform the user that a friend in the social network has posted content to social network server 160 that is associated with the video program that the user is viewing. The user can then elect to view this content at the same time that they are watching the video program.

Content searcher application 232 searches for public content associated with the video program that the user is currently viewing. Unlike the social network application 231, the content identified and retrieved by content searcher application 232 is not limited to materials posted to a particular social network or a single internet domain. The user of tablet 190 may configure content searcher application 232 to retrieve content only from specific locations or only content that has been generated by specific individuals or organizations.

In order for the waymark update service 221 to provide TV program identification and tracking information to application programs 230, an active tracking session is initiated between the TV track service 220 on tablet 190 and the set-top box 130. An application 230 may request creation of a session by waymark service control 222. Once a session is initiated the waymark update service 221 will provide periodic viewed programming updates that identify whether the user is watching an identified video program and if so what video program that is and what playback location within the program the user is presently watching. In addition, the waymark update service 221 may specify the playback mode, i.e. whether playback is proceeding at normal rate, is stopped or is in a mode in which playback is not proceeding at a normal rate, such as a rewind or fast forward mode. Finally, the waymark update service 221 provides a stream of waymark data to applications 230, identifying which specific waymarks within the video programming have been reached.

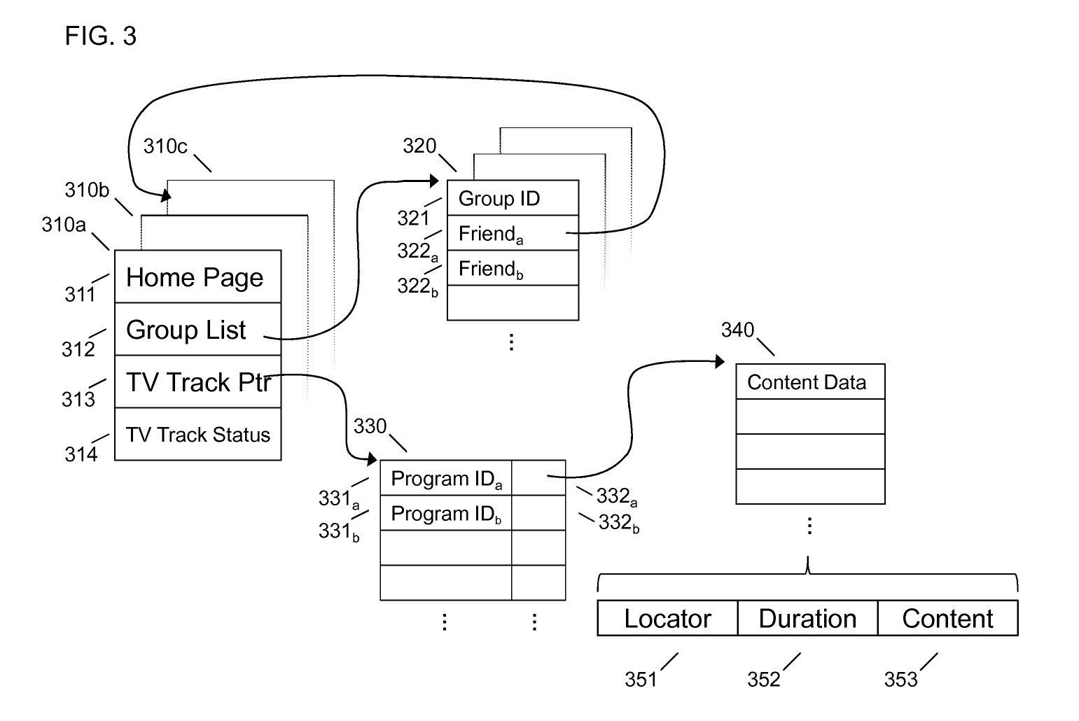

The organization of data on a content server 160 that hosts a social network service in one embodiment of the invention is illustrated in FIG. 3. The data structures illustrated in FIG. 3 can be used by a social network that allows members of the social network to maintain home pages that host information about themselves and to associate with other individual users (“friends”) or with groups of users of the social network. By associating themselves with other users or groups of users, the members of the social network can gain access to material published by those other users while granting those other users access to the material that they have published on their home pages. These basic features are common to many current social networks.

The data specific to a particular user of the social network is contained in a user data set 310. In FIG. 3 multiple such user data sets 310a, 310b and 310c are illustrated. In this embodiment of the invention, each user data set 310 includes home page data 311, a group list 312, a TV track pointer 313 and a TV track status indicator 314. The home page data 311 contains, or at least references, the various data associated with the user's social network home page. The group list 312 identifies the various groups or associations that this particular user is a member of. In the embodiment shown in FIG. 3 the group list 312 identifies membership in a group by pointing to a group membership structure 320 for that group. In FIG. 3 a single arrow is depicted running from the group list 312 to a single group membership structure 320. Typically a social network user might be a member of multiple groups and group list 312 might include multiple references or links to multiple group membership structures 320. An individual friend of the social network user can be represented in the database as a group of one member.

TV track pointer 313 references a program list 330. Each program list links to a set of user commentary 340 that contains content linked by the user of the social network to a particular part of the video program identified in the associated entry in program list 330. TV track status indicator 314 provides information about whether this particular user is currently watching specific video programming, and what that programming is, as described in greater detail later herein.

Each group membership structure 320 contains a group identifier that identifies the specific group, and a list of multiple friend fields 322, each of which identifies a member of the group. Each friend field 322 provides a reference to the user data page 310 of each of the friends that make up the group. Only one such link is illustrated in FIG. 3, but each friend field 322 in group membership structure 320 would include such a reference.

Program list 330 contains a list of TV programs with which this specific user has associated TV linked content. Each entry in the program list includes a program identifier 331 that identifies the TV program and a reference 332 to a set of user content 340 that this specific user has linked to this program. In one embodiment the program identifier 331 may include a network resource locator, such as a URL, that identifies a TV track server 150 and a program index that identifies a particular video program for which a program track is hosted on that TV track server 150.

The set of user content 340 referenced from program list 330 contains one or more content structures 350, each of which corresponds to content linked by the social network user to a specific part of a video program. The content structure 350 contains a locator 351 that identifies a location in the video program. Locator 351 identifies the starting point of the passage from the video program to which the user's content is relevant. The locator specifies locations within the video program by reference to waymarks as described in greater detail herein.

Content structure 350 also includes a duration field 352. Duration field may contain one or both of two different types of information. The first type of information is a terminating location that serves as a counterpart to locator 351 in that the terminating location identifies a location in the video program that marks the end of the video passage to which the content is relevant. The second type of information is a presentation duration measure which identifies for how long the content should be presented to the viewer. The final element in content structure 350 is content field 353. User content field 353 references the data the user of the social network has generated and associated with the particular location in the TV program identified by locator 351 and duration field 352. This user generated data can take the form of text, audio, video or other digital data.

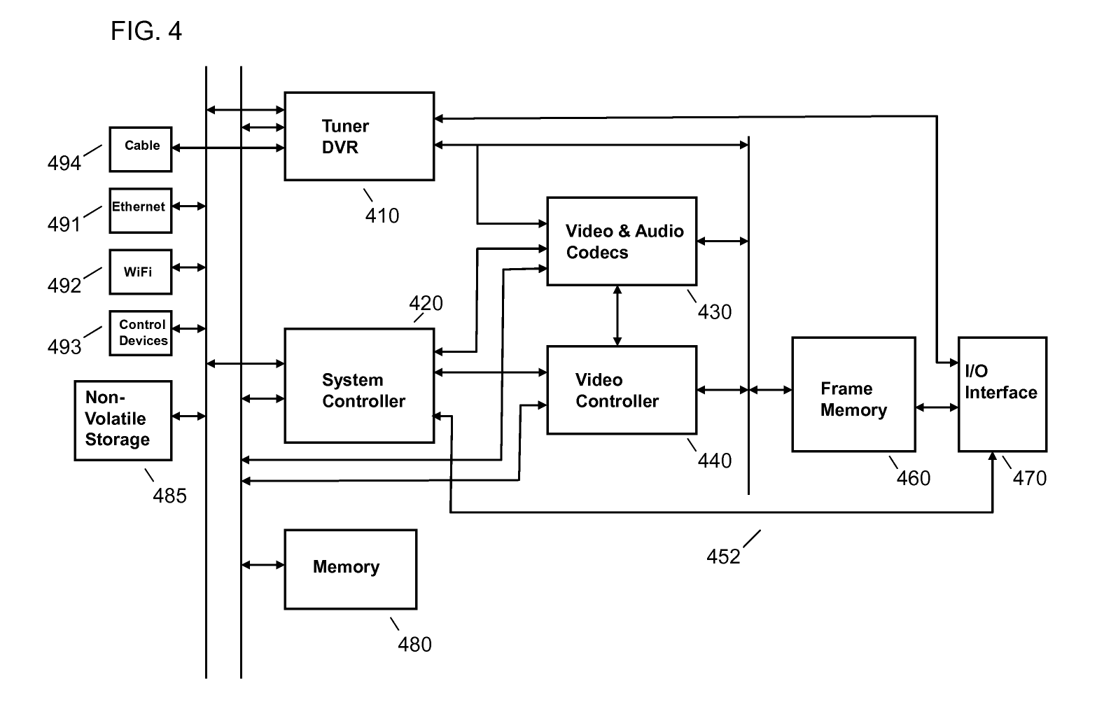

FIG. 4 is a diagram of the arrangement of the major functional blocks in set-top box 130 in one embodiment of the TV interaction system where set-top box 130 includes a TV tuner and DVR function 410 as well as TV interaction system functions.

The set-top box 130 includes a tuner/DVR block 410 and a system controller block 420. Tuner/DVR function 410 and system controller 420 are also connected to a memory 480 and to support functions including a wired network interface 491, such as a wired Ethernet port, a wireless network interface 492, an interface for input/output control devices 493, such as a USB port, and a non-volatile storage device 485, such as a disk driver or flash memory. Tuner/DVR function 410 is also connected to cable interface 494 which allows the set-top box 130 to be connected to a coaxial cable for receiving high-bandwidth data from a cable system. Tuner/DVR function 410 can receive video programming signals through cable interface 494 from a cable television service provider or over a packet network through wired network interface 491 or wireless network interface 492.

The set-top box 130 also includes a collection of video and audio codec functions 430, and a video controller function 440. Functions 430 and 440 can be implemented as software functions on one or more CPUs or digital signal processors (DSPs), as dedicated circuit elements, or as a combination of both dedicated hardware and software. While the functions are illustrated as separate blocks in FIG. 4, this is for ease of explanation and is not intended to indicate any particular implementation of these functions. In one embodiment of the invention these three functions could be implemented in a single processor.

The tuner/DVR function 410, the video and audio codec functions 430, and the video controller 440 are all connected to video frame memory 460 that stores frames of video and audio data. While frame memory 460 is illustrated as separate from memory 480, in one embodiment they may be integrated into a single memory.

I/O interface 470 generates video and audio output signals for set-top box 130. These output signals can be supplied in analog or digital formats. For example, the I/O interface 470 may provide video and audio signals in a standard digital format such as HDMI. The I/O interface 470 can receive video and audio signals from tuner/DVR function 410 when no decoding of the signal is required and can access frame memory 460 to retrieve frame data for transmission as a video output signal and audio data for generation of audio outputs. I/O interface 470 also has a control signal interface with system controller 420 for exchanging control information. In addition, I/O interface 470 may also be able to receive video and audio signals from “upstream” devices connected to signal interfaces supported by the I/O interface 470 such as a DVD or Blu-Ray player. The I/O interface 470 can be configured by system controller 420 to store incoming video and audio signals received from another device in frame memory 460.

The tuner/DVR function 410 receives video programming by way of one of cable interface 494, wired network interface 491 or wireless network interface 492. The tuner/DVR function 410 can store video programming in frame memory 460 as the video programming is received. If the programming is not encoded it can be assembled into frames in frame memory 460 and read by I/O interface 470 for display. More commonly, however, the video programming is encoded. In that case, the encoded video data must be decoded before it can be presented. To enable this the video and audio codec functions 430 retrieve data from the frame memory 460, decode it and write it back to frame memory 460, where it can be read by I/O interface 470 for display.

The system controller 420 implements the various control functions required for operation of both the DVR and the TV interaction system.

The video and audio codec functions 430 implement codecs for encoding and decoding video and audio content. The video and audio codec functions 430 can be used for encoding received video programming for long-term storage in non-volatile storage 485 and for later decoding stored data for playback. When the video and audio codec functions 430 are used for encoding data they typically retrieve a block of frame data from one region of memory 480, encode it and write it back to another region of memory 480. The encoded data can then be transferred by the system controller 420 to non-volatile storage 485.

Frame memory 460 is used to store video and audio data that is to be outputted from the set-top box 130 for presentation on a connected device, such as monitor 110. Video and audio data is stored in frame memory 460 in a format in which it can be quickly converted by I/O interface 470 for transmission on audio and/or video outputs. I/O interface 470 is connected to, and can retrieve data from, frame memory 460. I/O interface 470 converts stored video frames into analog signals for output as composite or component video signals, or reformats the frame data for transmission on a digital interface such as HDMI.

The operation of the I/O interface 470 is controlled by system controller 420 through a control signal connection 452. System controller 420 specifies parameters for I/O interface 470 that may include properties such as what output interfaces are to be driven, the rates and resolutions for video outputs and master volume levels for the audio outputs. In addition, the system controller 420 may also specify values for various other parameters carried by a digital interface such as HDMI.

In addition, I/O interface 470 may also receive “upstream” control signaling across a digital interface from other devices connected by external signals to the I/O interface 470, such as monitor 110. HDMI, for example, includes a Consumer Electronics Control (CEC) link that allows one HDMI device to pass configuration and control information to other HDMI devices. When I/O interface 470 receives CEC communications from another device across one of its HDMI interfaces, the content of these communications is provided to system controller 420 for processing. Likewise any outgoing CEC communication is generated by system controller 420 and conveyed to I/O interface 470 for transmission across the appropriate HDMI link.

Video and audio signals may be received and transmitted in an encrypted format. HDMI cabling, for example, can be used to carry encrypted data. I/O interface 670 may include the ability to encrypt audio and video information to be transmitted and to decrypt received audio and video signals in accordance with the requirements of relevant signal transmission standards. System controller 420 may provide relevant control and key information for the encryption and decryption process.

### Data Formats

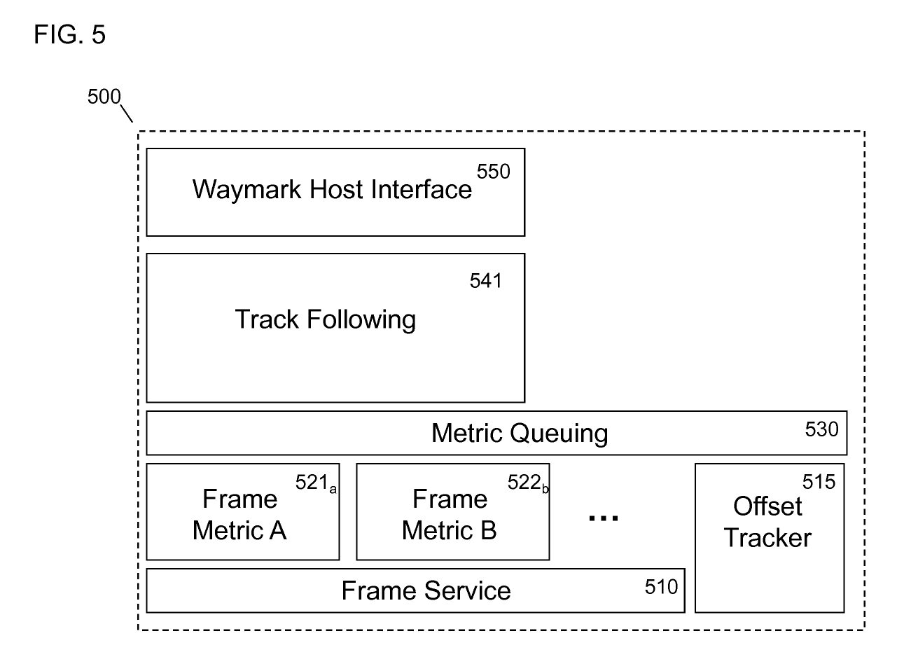

In one embodiment of the invention, the system controller 420 uses data received from TV track server 150 to implement a video waymark host 500, as illustrated in FIG. 5.

The content of the data received from TV track server 150 will be discussed with reference to data structure definitions in Table 1, which define a set of data structures that could be used in one embodiment of the invention. The data structure definitions in Table 1 follow a format similar to the Abstract Syntax Notation One (ASN.1) format defined by the ISO and ITU. The data structure definitions in Table 1 are examples intended to show one possible arrangement of the data that could be supplied by TV track server 150 to allow specific passages of a video sequence to be identified.

TABLE 1
Distance-measure ::= CHOICE {

| | |
|---|---|
| frame-count | INTEGER, |
| time-count | Seconds } |

Time-reference ::= SET {

| | |
|---|---|
| waymark-id | Waymark-index, |
| sequence-num | INTEGER, |
| time-index | Seconds } |

Position-reference ::= SET {

offset Distance-measure OPTIONAL,
waymark-ref Waymark-index }

Metric-entry ::= SET {

| | |
|---|---|
| metric-type | INTEGER, |
| metric-value | Metric-vector, |
| position | SEQUENCE OF Position-reference |
| | OPTIONAL } |

Waymark-entry ::= SET {

| | |
|---|---|
| waymark-ref | Waymark-index, |
| position | SEQUENCE OF Position-reference |
| | OPTIONAL, |
| public-flag | BOOLEAN } |

TV-track-stream ::= SEQUENCE OF CHOICE {

| | |
|---|---|
| metric | Metric-entry, |
| waymark | Waymark-entry } |

Time-reference-stream ::= SEQUENCE OF Time-reference

The data structures in Table 1 define two data streams: a TV-track-stream and a Time-reference-stream. The TV-track-stream data set consists of two types of data: a Waymark-entry and a Metric-entry. A Waymark-entry is composed from a Waymark-index, a list of Position-references and a flag indicating whether the waymark defined by the Waymark-entry is public or private. The ASN.1 constructor SET used to define the Waymark-entry and Metric-entry data structures indicates a grouping of data composed from the objects identified in the brackets following the word “SET.” Waymark-indexes are tags that can be used as reference points for identifying a particular location, or waymark, in the playback of a video stream. Position-references are distance measures that identify how far (and in what direction, i.e. reverse or forward) a metric or another waymark is distant from a waymark being used as a point of reference. The Position-reference data structure uses a Distance-measure data structure that permits distance measurements to be made either in numbers of frames or seconds. The ASN.1 constructor CHOICE identifies a selection from alternative data items enumerated in the brackets following the word “CHOICE.” Table 1 does not include a terminal definition for the data representation for the Seconds data type used to measure time. An appropriate representation of time units will depend upon the frame rates supported by the system. Standard frame rates vary from 24 to 72 frames per second. Any time unit that allows for resolution of the highest frame rate will be sufficient.

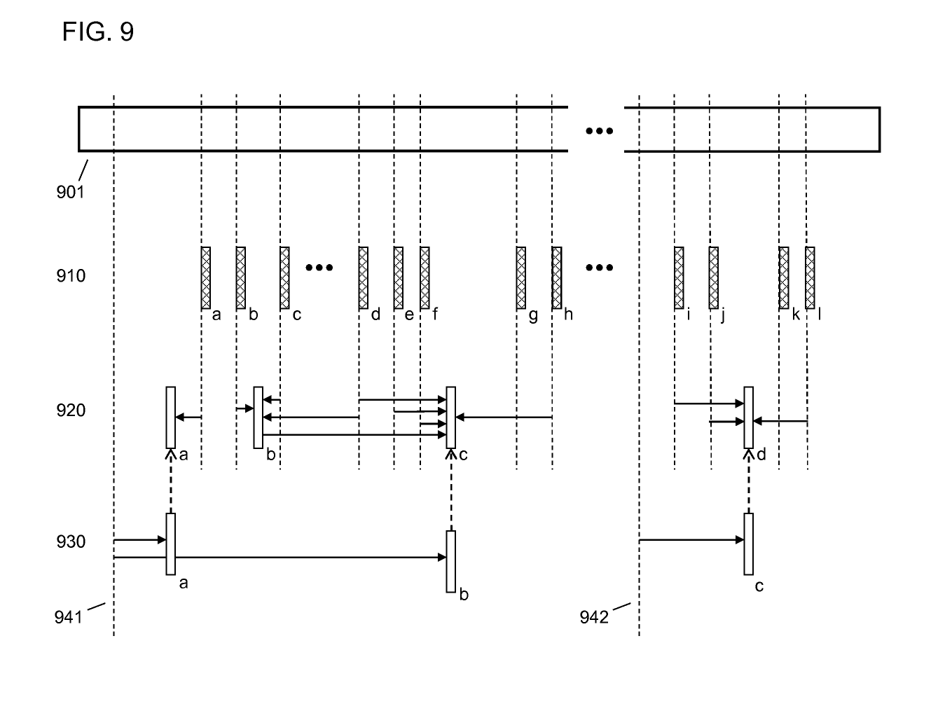

The relationship between the Waymark-entries, Metric-entries and Time-references defined in Table 1 is illustrated in FIG. 9. The horizontal axis across FIG. 9 corresponds to the progress of time. At the top of FIG. 9 is depicted a video program 901 running horizontally through time. Various video metrics 910ₐ . . . 910ₗ are illustrated as being located at different points in time. Running vertically adjacent to video metrics 910, and through the video program 901, are a set of dashed lines that identify points in the video program from which the video metrics 910 are derived.

Below the video metrics 910 are waymarks 920a . . . 920d. Horizontal lines are shown running from some of the vertical dashed lines to one or more waymarks 920. These arrows represent the one or more Position-references included in a Metric-entry that identify a waymark and an offset measuring the distance from the Metric-entry to that waymark. For example, metric 910a is illustrated as having a Position-reference to waymark 920a and metric 910d is illustrated as having Position-references to waymarks 920b and 920c.

Waymarks provide a way to identify a specific point in the video stream. To serve that function a waymark-ref value must be used exclusively by a single waymark. It is advantageous if the waymark-ref values in the Waymark-entries increase monotonically with progress through the video so that the TV interaction system can determine sequencing of waymarks simply by comparing their waymark-ref values.

Each Waymark-entry data structure also includes a public-flag value. This indicates whether or not the waymark may be used as a reference point for associating content. Only public waymarks are to be used as content reference points.

Ideally the data format used for waymarks should allow insertion of new waymarks between existing waymarks so that the set of waymarks used in a video track can be expanded if needed. A simple way to achieve this is to use integers as waymark-ref values but to ensure that sufficient space is left between the waymarks when they are initially defined. A slightly more complicated strategy is to allow waymark-ref values to be extended by making it possible to insert an intermediate range of values as needed between two previously adjacent waymark-ref values. One implementation of this is shown in Table 2.

TABLE 2

| Waymark-index ::= | Extensible-num | |
|---|---|---|
| Extensible-num ::= | SET { | |
| | base | INTEGER (0 .. MAX) , |
| | extension | Extensible-num |

( WITH COMPONENTS {

...,
base (0 <.. MAX) } ) OPTIONAL }

An Extensible-num consists of a base value which is a non-negative integer, and an optional extension, which is recursively defined as another Extensible-num object that is restricted to having a base value greater than zero. An ordering for a set of Extensible-nums can be defined by comparing their base fields. If two or more Extensible-nums have the same base value, their ordering can be determined by comparing the base field of their extensions. For purposes of this comparison an Extensible-num that does not include an extension should be considered to have an extension of value 0.

The Metric-entry objects in Table 1 define a metric-type, and can include a metric-value vector of values that results when the metric is applied to a particular frame or to a set of frames if the metric is one that applies to multiple frames. A Metric-entry may also include a set of one or Position-references that relate the metric to one or more waymarks. In ASN.1 the SEQUENCE OF constructor identifies an ordered list of items all of the same type, where the list can have zero or more entries. If a Position-reference is not specified, the Metric-entry is impliedly collocated with the last waymark object identified in the stream. Table 1 does not include a definition for the type Metric-vector. Because different types of metrics will produce different result vectors, the particulars of the data type used for presenting metric result vectors will be different for each different type of metric.

### Video and Audio Metrics

In the technical literature on matching and retrieval of video sequences, a variety of techniques have been proposed for doing video image comparisons. One technique that is commonly used is to segment an image into different regions and to produce a histogram of the measured image properties, often the color planes (e.g. RGB and YUV color separations). See Schettini et al., “A Survey of Methods for Colour Image Indexing and Retrieval in Image Databases;” Gong et al., “Image Indexing and Retrieval Based on Color Histograms,” Multimedia Tools and Applications, vol. 2, pp. 133-156 (1996); Kashino et al, “A Quick Search Method for Audio and Video Signals Based on Histogram Pruning,” IEEE Trans. on Multimedia, vol. 5 no.3 (September 2003). While three color planes can be used it is common to segment the image colors even further. For the purposes of this discussion we will refer to the YUV planes with the understanding that a larger number of color segments could be used. Alternatively, only a subset of the colors could be used for the purposes of generating metrics and conducting frame comparisons. An alternative method of characterizing a video frame is to analyse the frame's spectral properties using discrete cosine transforms (DCT) or wavelet decomposition. See Naphade et al., “A novel scheme for fast and efficient video sequence matching using compact signatures,” Proc. of SPIE Conf. on Storage and Retrieval for Media Databases (January 2000) and Liu, “Image Indexing in the Embedded Wavelet Domain,” M.S. Thesis, Univ. of Alberta (2002). Other techniques involve extracting texture or shape information from the image. In “Robust Video Fingerprinting for Content-Based Video Identification,” IEEE Transactions on Circuits and Systems for Video Technology, vol. 18 no.7 (July 2008), pp. 983-988, Lee & Yoo describe calculating the centroid of grayscale pixel gradients in the two dimensions of the video image and using this centroid of the various regions of the image as an identifying feature of the image. One or several of these techniques can be used to derive feature metrics for video frames.

Another property that may be useful in characterizing video frames is the measure of frame divergences from prior frames. Key frames are frames that mark the beginning of a new shot or scene and they are identified by a high degree of divergence from prior frames. See, Costaces et al., “Video Shot Boundary Detection and Condensed Representation: A Review,” IEEE Signal Proc., vol. 23 no.2 (March 2006); Kim & Park, “An Efficient Algorithm for Video Sequence Matching Using the Modified Hausdorff Distance and the Directed Divergence,” IEEE Trans. on Circuits and Systems for Video Technology, vol. 12 no.7 (July 2002). In the TV interaction system, divergence measures may be used as frame metrics with frames that have a high degree of divergence from the previous frame. Such frames are relatively easy to identify at a device such as set-top box 130 that is trying to develop a correspondence between an observed video stream that it is presenting and a received set of frame metric data. Alternatively, key frames can be selected based on divergence from an average of a window of previous frames or based on a cumulative divergence calculated as a sum of divergences over previous frames scaled by the time size of the window to avoid frame rate comparison problems.

There are many possible measures for frame divergence that can be used. Techniques for measuring the divergence of color histograms include the histogram intersection measure and the Euclidean and Quadratic distances between the two histograms. The Quadratic distance is measured by:

$${\sum }_{z} {( {F}_{1 , Y} ( z ) - {F}_{2 , Y} ( z ) )}^{2} + {( {F}_{1 , U} ( z ) - {F}_{2 , U} ( z ) )}^{2} + {( {F}_{1 , V} ( z ) - {F}_{2 , V} ( z ) )}^{2}$$

where F₁(z) and F₂(z) are the color values for the first and second frames to be compared, the subscripts Y, U and V denote the various color planes and z ranges across the various regions of the image. (As discussed above fewer or more than three planes may be used; the use of YUV here is merely an example.) The values F₁(z) and F₂(z) may constitute histograms of the color components of the region. The contributions of each color plane can be separately weighted if desired. The histogram intersection and Euclidean measures are described in Swain & Ballard, “Color Indexing,” Int'l J. of Computer Vision, vol. 7 no.1 (1991); and Liu.

An alternative measure is the “directed divergence” measure used in Kim & Park which accumulates the divergences between the two frames across all regions of the frame and color planes. The directed divergence is given as:

$${\sum }_{z} {F}_{1 , Y} ( z ) log \frac{{F}_{1 , Y} ( z )}{{F}_{2 , Y} ( z )} + {\sum }_{z} {F}_{2 , Y} ( z ) log \frac{{F}_{2 , Y} ( z )}{{F}_{1 , Y} ( z )} + {\sum }_{z} {F}_{1 , U} ( z ) log \frac{{F}_{1 , U} ( z )}{{F}_{2 , U} ( z )} + {\sum }_{z} {F}_{2 , U} ( z ) log \frac{{F}_{2 , U} ( z )}{{F}_{1 , U} ( z )} + {\sum }_{z} {F}_{1 , V} ( z ) log \frac{{F}_{1 , V} ( z )}{{F}_{2 , V} ( z )} + {\sum }_{z} {F}_{2 , V} ( z ) log \frac{{F}_{2 , V} ( z )}{{F}_{1 , V} ( z )}$$

The video metric data contained in Metric-entry items can be raw data characterizing properties of the video frame, or it may be quantized. The video metrics may also be composed of ordinal rankings of image regions or image properties based on their values. Ordinal rankings of properties such as divergence provide a video signature that is less sensitive to variations in frame rates, contrast and illumination or other variations in image quality introduced by different encoding techniques. The use of ordinal rankings in video comparison is described in Chen & Stentiford, “Video Sequence Matching based on Temporal Ordinal Measurement,” Pattern Recognition Letters, vol. 29, no.13 (October 2008).

The passages from the references discussed above describing alternative techniques for calculating feature vectors (Liu §2.3, Lee & Yoo, §II, Schettini §§3 & 4, Swain & Ballard §2) and techniques for measuring video divergence or similarity (Liu §2.3, Kim & Park §II, Lee & Yoo §III and Swain & Ballard §3) as well as the description of shot boundary detection in §II of Cotsaces and the use of ordinal ranking sin Chen & Stentiford are incorporated herein by reference.

Different types of metrics may be suitable for different types of video sequences and for different functions in the TV interaction system. For example, video images that are relatively static may best be characterized by a metric that is derived from the image data of a single frame and is derived from the colors or configuration of elements in that single video frame. A sequence of video that is very dynamic and fast moving may be best characterized by a metric that quantifies what portions of the image are changing and at what rates. When the video imagery is entirely static, metrics derived from accompanying audio may be used to identify a particular playback position within the video.

In the Metric-entry data structure defined in Table 1, the metric type is identified by an integer, allowing different types of vectors to be identified by an integer code and leaving room for new metrics to be defined later. Set-top box 130 should be capable of applying a basic set of metrics to a video image. If the waymark stream includes a suitable variety of metrics, the set-top box 130 may be able to match the video that it is processing to waymarks identified in a TV-track-stream even if it can only generate a subset of the types of metrics employed in the stream. Additionally, the TV track server 150 may provide a list identifying all of the types of metrics employed in a TV-track-stream to set-top box 130. The set-top box 130 can then retrieve code from a support server, not shown in FIG. 1, to enable it to calculate metrics identified in the list of metric types if set-top box 130 did not previously have that capability.

The Time-reference-stream defined in Table 1 provides a time index into the sequence of waymark-entry and metric-entry objects contained in the TV-track-stream. The Time-reference-stream allows the TV interaction system to easily skip backwards or forwards in units of time through the set of waymarks and metrics in the TV-track-stream. The Time-reference-stream is composed from a sequence of individual Time-references, each of which identifies the position of a waymark in terms of elapsed time, from a fixed reference point in the video stream. One reference point is used for each continuous sequence of video so that it is possible to identify a waymark displaced some specified amount of time from the waymark closest to the viewer's current location.

Use of Time-references can be understood with reference to FIG. 9, which includes Time-references denoted as 930ₐ . . . 930_{c}. Time references 930ₐ and 930_{b} identify a distance relationship between waymarks 920ₐ and 920_{b} and sequence time reference point 941 in video program 901. Time reference 930_{c} identifies a distance relationship with sequence time reference point 942. The existence of multiple sequence time reference points 941 and 942 may arise when there are multiple sequences in a video stream and the timing relationship between those sequences is not definitively fixed. For example, frames in one sequence might be separated from frames in another sequence by commercials having a duration that may vary in different broadcasts of the program. Each Time-reference includes a sequence-num field that provides a unique identifier for a sequence of frames. Every Time-reference with a common sequence-num uses a common sequence time reference point so that all of the time-index values for Time-references with a common sequence-num can be compared directly to determine the absolute distance between waypoints.

The horizontal arrows linking time references 930 to the different sequence time reference points 941 and 942 correspond to the time-index measurements in each Time-reference object that identify the amount of time elapsed from the sequence time reference point to the time references 930. Each time reference 930 is associated with a waymark identified in the waymark-id of the Time-reference data structure. This relationship between Time-references and waymarks is illustrated in FIG. 9 by vertical dashed arrows running from the time references 930ₐ . . . 930_{c} to a waymark, such as from time reference 930_{b} to waymark 920_{c}.

The Time-reference-stream makes it possible for set-top box 130 to quickly find its place in the TV-track-stream based on an estimate of how many minutes and seconds into a video program the viewer currently is. The set-top box 130 is often able to ascertain approximately how far the user is into a program based on its knowledge of the current time and the TV schedule. This information can be used with the Time-reference-stream to identify an offset into the sequence of Waymark-entry items to begin searching around. There is no limit to the number of Time-references that may be included in the waymark stream. Including more Time-references allows for greater resolution and in searching but has the disadvantage of increasing the size of the Time-reference-stream.

The Time-reference-stream is an optional accompaniment to the TV-track-stream. If there are sufficient Position-references included in the Metric-entry and Waymark-entry items in the TV-track-stream it may be possible for the TV track host to derive a timing reference for the waymarks from the TV-track-stream alone. For example, in FIG. 9 it is possible to derive a distance relationship between metrics 910_{b} and 910ₕ because the Metric-entry 910_{b} references waymark 920_{b} which is also referenced by Metric-entry 910d which also references waymark 920_{c} and waymark 920_{c} is also referenced by Metric-entry 910ₕ. Adding up the various offset values for each of the Position-references in this chain allows for determination of the amount of elapsed time or number of frames between the 910b and 910h. Alternatively, FIG. 9 also depicts that there is a timing relationship defined between waymarks 920_{b} and 920_{c} which could be used to determine the amount of elapsed time or number of frames between waymarks 920_{b} and 920_{b}.

In the data structures specified in Table 1 the sequence of Metric-entry and Waymark-entry items that make up the TV-track-stream are treated as a single sequence of data. While this data could be transferred to set-top box 130 as a single block transfer, it may be more advantageous to transfer the TV-track-stream in multiple pieces, with the set-top box 130 only requesting the portion of the stream containing waymarks and metrics for the video segment that the set-top box 130 is currently presenting and for some window of time into the future. In the case of live video programming, the TV track server 150 may be adding to the collection of metrics and waymarks that make up the TV-track-stream as the set-top box 130 presents the programming. In that scenario it may be necessary for the TV-track-stream to be transmitted in a series of ongoing transfers. The techniques for conducting any of these types of transfers will be familiar to persons of ordinary skill in the art.

In addition to the data described in Table 1, the TV track server 150 and the set-top box 130 may need to exchange various control data for configuring communications between these two devices. Details regarding the type of data that would be exchanged to configure data transfer sessions between these devices will be familiar to persons of ordinary skill in the art and are not described in Table 1.

FIG. 5 illustrates some elements of a video waymark host 500 in accordance with one embodiment of the invention in which video waymark host 500 is implemented as software executing on set-top box 130. The functional units in FIG. 5 are arranged hierarchically in order to show the layers of interaction between the various elements of the video waymark host 500. A functional unit in this hierarchy may receive information from the functional units below it and provide services and information to the functional units above.

The video waymark host 500 evaluates the stream of video frames and audio data that flows from set-top box 130 to monitor 110. The video waymark host 500 derives metrics from the current video frames and audio data. If TV track server 150 provides a TV-track-stream for the current program to set-top box 130, the video waymark host 500 attempts to correlate the video and audio metrics that it calculates from the program video and audio against the metrics that are supplied in the TV-track-stream from TV track server 150. If video waymark host 500 can match metrics, it can then provide waymark data that identifies the current position of the video program to tablet 190 or any other device requesting such data that is connected to set-top box 130 through the LAN.

With reference to FIG. 5, the frame service 510 at the bottom of the hierarchy provides access to the video frame data that is being prepared by the set-top box 130 for transmission to a display device such as monitor 110, or that has already been presented but remains available in the set-top box 130. With reference to FIG. 4, in one embodiment frame service 510 can be thought of as providing access to the frames stored in frame memory 460. The frame service 510 provides higher level functional units with access to video frame data and accompanying audio information.

The frame metric functions 521ₐ and 521_{b} generate metric data that characterizes a frame or sequence of frames based upon an algorithm specific to that functional unit. While only two frame metric functions 521 are illustrated in FIG. 5, a larger, or smaller, number of frame metric functions may be used. Each metric function employs a different algorithm for characterizing the frame data.

Offset tracker 515 keeps track of the progress of set-top box 130 through the video. Offset tracker 515 can provide a frame sequence identifier and frame index for each frame supplied by frame service 510. The frame sequence identifier provided by offset tracker 515 is an identifier that is unique to each continuous sequence of video frames that is transmitted by set-top box 130 in normal playback mode. Each frame in a continuous sequence of video has a unique frame index. The number of frames separating one video frame from another in the same sequence can be determined by comparing the frame index values provided for each of the two frames to be compared. In one embodiment the offset tracker 515 is informed by the set-top box 130 when playback is paused or placed into a “trick play” mode such as slow motion, fast forward or reverse. A pause temporarily suspends playback of a sequence of video but does not necessarily terminate the sequence, as the user may resume forward progress through the sequence by hitting play. However, slow motion, fast forward or reverse may end a sequence of frame index values generated by offset tracker 515 if the set-top box 130 is not able to keep an accurate count of the number of frames it is advancing or rewinding through in one of these modes. Some set-top boxes may have indexing capability that allows them to count the progress of frames in one of these “trick play” modes and with some content. In that case, use of one of these modes need not cause offset tracker 515 to terminate its use of the existing sequence identifier. Higher level functions in FIG. 5 can determine which frames are in the same playback sequence by comparing the frame sequence identifiers produced by offset tracker 515 for each of these frames. Only frame index values of video frames that have the same frame sequence identifier may be meaningfully compared to determine relative position.

Metric queuing function 530 stores a window of the most recent metrics generated by frame metric units 521 along with the corresponding frame sequence identifiers and frame indices generated by offset tracker 515.

In one embodiment of the invention, the frame service function 510, the frame metric calculation functions 521, the offset tracker function 515 and at least part of the metric queuing function 530 are implemented by video controller 440. Video controller 440 is able to retrieve video frames from frame memory 460 in order to implement frame service function 510. The frame metric functions 521 can be implemented by software modules that execute on video controller 440. The offset tracker function 515 is also implemented by video controller 440. System controller 420 communicates with video controller 440 to indicate when normal playback has been interrupted, either because the user has elected to change the programming, has suspended playback or has initiated a trick play mode such as fast forward, slow motion or rewind. As a result, video controller 440 is able to identify where frame sequences played at a normal rate begin and end and to supply a frame sequence identifier and frame offset value for the current frame to higher layer functions above the offset tracker function 515. The results of the metric calculations and the accompanying frame sequence identifier and frame index identifying the frames that generated these metrics can be stored in memory 480 as part of the metric queuing function 530.

Above the metric queuing function 530 in FIG. 5 is track following function 541 which uses the metric data from metric queuing function 530 to compare current metrics for video playback against metrics from an established TV-track-stream for a video program in order to track the forward progress of the current video against the waymarks in the TV-track-stream. Track following function 541 determines whether the current metrics generated by frame metric functions 521 correspond to the metrics contained in the reference TV-track-stream. If track following function 541 determines that the current video in playback does correspond to the reference track it identifies the current position within the video by reference to the waymarks identified in the TV-track-stream data as being closest to this section of video. The track following functions 541 can then convey to higher level functions, such as waymark host interface 550, that the set-top box 130 has reached these particular waymarks.

There are two elements to tracking progress of the video program presented by set-top box 130 through the metrics and waymarks contained in a TV-track-stream. The track following function 541 must first identify a correspondence between the frames that it is presenting and a set of metrics in the TV-track-stream. Once a relationship has been established between a frame in the video and a frame offset in the TV-track-stream, track following function 541 must monitor subsequent video frames to verify that the correspondence continues in subsequent frames. If set-top box 130 established a correspondence between a frame at index iₐ and metric Zₐ it should be able to identify a similar correspondence between metric Z_{b} and a frame at index iₐ+Δ when the TV-track-stream data indicates that metrics Zₐ and Z_{b} are separated by C(Δ); where C( ) converts frame counts at the frame rate of the video being presented on set-top box 130 into a number of frames occupying the same amount of time at the frame rate used with the TV-track-stream data.

In order to identify an initial correspondence between video frames and TV-track-stream metrics the set-top box 130 can use the information set-top boxes normally have about how far into the video the current presentation is and the Time-reference-stream information to identify an approximate location within the sequence of waymarks to begin searching. In the seek algorithm discussed below this search starting point reference into the TV-track-stream data is referred to as k₀. In one embodiment of the invention the track following function 541 then utilizes the seek algorithm described below to find a correspondence between a specific frame in the video and an offset in the TV-track-stream. Once this correspondence has been identified the track following algorithm, also described below, can be deployed to verify that the correspondence between new video frames and subsequent metrics continues to hold as the video advances.

The description of the seek algorithm and the track following algorithm both refer to index values i for frames in a frame buffer like frame memory 460 as well as offsets k in a TV-track-stream. The frame rate used with the TV-track-stream may be different than the frame rate for the video that is presented by the set-top box 130. At various points in the algorithm incremental offsets in the TV-track-stream data are used to calculate expected offsets in the video stream and vice-versa. If the frame rates are different a conversion must be performed so that the amount of time covered by any frame count is the same in both domains. Additionally, index values i should be understood as identifying frame indexes in a video sequence of consecutive frames. The frame index values range between 1 and K_{FB}, where the frame with 1 is the first frame in the sequence and K_{FB} is the total number of accessible frames. The i index values do not represent absolute indexes in a complete video program; they represent relative indexes into a particular video sequence that is available for analysis in the buffers of the set-top box 130. The video sequence may be stored in frame memory 460 but the i index values are not to be interpreted as memory addresses. In one embodiment the frame memory 460 would be organized as a FIFO and the i frame index values would need to be converted to address values before they could be used to retrieve the contents of frame number i from frame memory 460.

### Seek Algorithm

Step 1: Given an estimated offset into the TV-track-stream data of k₀, identify the metric Z_{X}, at offset kₓ, that is closest in proximity to offset k₀.
Step 2: For each index i in a window iε{1, . . . , K_{FB}} calculate the prediction error value εₓ(Zₓ,Fₓ(V[i])) and identify all i for which εₓ(Zₓ,Fₓ(V[i]))<β_{threshold}. Here V[i] is the video frame data for the video frame at offset i; K_{FB} is the number of frames in the video sequence contained in the frame buffer that may be compared with frame metrics; β_{threshold} is a minimum error threshold for identifying a possible match between frames and metrics; and Fₓ(V[i]) is the function for calculating the metric of frame V[i] where the type of metric calculated is the same metric type that was employed to calculate metric value Zₓ.

εₓ(Aₓ,Bₓ) is a measure of the error between metrics A₁ and Bₓ. The particular nature of the error function will depend upon the type of metric results that may need to be compared. The x subscripts are used to indicate that the error measure function is specific to the type of metric function that was used to derive metrics Aₓ and Bₓ. For example, some metrics may produce single value results within a range of 0 . . . 1, other metrics may produce a result vector having values distributed over a much broader range. The error measure εₓ(Aₓ,Bₓ) for each metric should produce a single valued error measure that can be compared against error measures of other types to get a comparable measure of the divergence or proximity between the calculated and received metric values. For example, if the metric values are single valued the error measure might be calculated as the absolute value of the difference between the two divided by a factor θₘ intended to normalize the range of the error measure: εₓ(Aₓ,Bₓ)=|Aₓ−Bₓ|θₘ.

Step 2-a: For each index i that met the threshold test in step 2, identify N metrics {Z₁ . . . Z_{N}} from the TV-track-stream data nearest to Zₓ at offsets {k₁ . . . k_{N}} that are no further than C (K_{FB}−(i+Δⱼ)) ahead of kₓ and no more than C (i−(1+Δⱼ)) behind kₓ and where N<K_{mc}. K_{mc} is a defined upper limit on the number of nearby metrics that are to be compared. Δⱼ is a search constant and C ( ) is a conversion function for converting frame counts at the frame rate of the video being presented by set-top box 130 to frame counts at the rate of the TV-track-stream data.

For each metric Zₙε{Z₁ . . . Z_{N}} identify the best fit metric γ_{i,n} by determining the minimum prediction error between Zₙ and the video frames in a narrow jitter window around the video frame V[i+Δₙ], where Δₙ=C⁻¹(kₙ−kₓ) is the distance between Zₓ and Zₙ expressed in the frame rate of the video using conversion function C⁻¹( ) for converting from the frame rate of the TV-track-stream data to the frame rate of the video on set-top box 130. That is:

\hat{β}_{i,n,j}=εₙ(Zₙ,Fₙ(V[i+Δₙ+j]))+αⱼᵢₜₜₑᵣ(|j|) for jε{−Δⱼ . . . +Δⱼ}

γ_{i,n}=min(\hat{β}_{i,n,j}) for jε{−Δⱼ . . . +Δⱼ}

Where ±Δⱼ defines the ranges of the jitter window; weighting function Δⱼᵢₜₜₑᵣ(|j|) is a function that increases monotonically from a value of zero at the origin and weights the error terms so as to give preference to the frames closest to the hypothesis offset of i+Δₙ.
Step 2-b: Calculate the aggregate metric value χᵢ for this i offset.

$${χ}_{i} = \frac{1}{N + 1} ( ( {\sum }_{n = 1}^{N} {γ}_{i , n} ) + {ɛ}_{x} ( {Z}_{x} , {F}_{x} ( V [ i ] ) ) )$$

If χᵢ<χ_{threshold} then terminate the search and declare that there is a correspondence between the frame at offset i in the frame sequence accessible in the frame buffer and the metric Z*=Zₓ at offset k*=kₓ in the TV-track-stream data. Otherwise, if there are remaining i values that met the threshold test of step 2, select the next value of i and repeat steps 2-a and 2-b for this i value.
Step 3: If all i values identified in step 2 are exhausted, then select a new metric candidate Z_{X} and offset kₓ to attempt to match to the received video frames and repeat all of step 2. Typically metrics both before and after the initial offset estimate of k₀ might be considered. However, if video is advancing forward during the execution of the seek algorithm and the contents of the frame buffer are being renewed with new frames, it may be appropriate to focus the search on metrics at offsets after k₀ rather than those significantly earlier.

### Track Following Algorithm

Once the seek algorithm has identified a match between a video frame offset in the frame buffer and an offset k* in the TV-track-stream data a track following algorithm is used to ensure that the correlation continues to be observed between subsequent video frames in the frame buffer and metrics from the TV-track-stream data.

The algorithm starts with information about: (i) the last offset k* in the TV-track-stream data correlated to a frame in the video, (ii) a count Δ_{to*} of the number of frames between the video frame that was correlated to k* and the frame V[i_{y}] at an index i_{y} in the video sequence currently accessible from the frame memory. The track following algorithm will then determine if there is a correlations between the frames around i_{y} and the metrics in the TV-track-stream at offsets advanced from k* by the same amount of time that separates V[i_{y}] and the frame correlated to k*. In other words, the track following algorithm tests the hypothesis that frame V[i_{y}] can be correlated to the offset k_{y}=C(Δ_{to*})+kₓ or at least an offset in the vicinity of k_{y}.

Step 1: Define a window of metric values Z_{w} at offsets k_{w} around offset k_{y} where k_{w}ε{k_{wMIN} . . . k_{wMAX}} and k_{wMIN}>k_{y}−C(i_{y}−Δ_{S}Δⱼ) and k_{wMAX}<K_{FB}+k_{y}−C(i_{y}−Δ_{S}Δⱼ). These constraints ensure that the metrics selected will not correspond to frames outside of the usable frame buffer. The maximum values of k_{wMIN} and k_{wMAX} should be further constrained to ensure that the searched metrics are within a maximum distance from k_{y}. Select a set of M metrics Zₘ where mε{1 . . . M} and each metric Zₘ is located at an offset kₘ where kₘε{k_{wMIN} . . . k_{wMAX}}. The metrics selected should be of the type suitable for matching of specific video frames. The number of metrics selected may reflect the amount of processing resources available to carry out tracking, and prior experience with accuracy of the track. For example if prior track following calculations have identified a high degree of correspondence (i.e. a low error signal) for comparisons between calculated metrics and the values received in the TV-track-stream data, then fewer metrics may be selected from the TV-track-data.

Step 2: For each offset i in a search window of ±Δ_{S}, calculate error values β_{i,m}, for the frames that correspond to each of the M metrics selected from the TV-track-stream data.

β_{i,m}=εₘ(Zₘ,Fₘ(V[i_{y}+i+Δₘ])+α_{search}(|i|) for iε{−Δ_{S}, . . . , +Δ_{S}}

Here Fₘ(A) is the function for calculating the metric of frame A where the metric calculated is the same metric type employed in calculating metric value Zₘ; εₘ(Aₘ,Bₘ) is a measure of the error between metrics A and B; and Δₘ=C⁻¹(kₘ−k_{y}) where C⁻¹( ) is a function for converting from frame counts at the frame rate of the TV-track-stream data to frame counts at the frame rate of the video on the set-top box 130. The common subscript m indicates that the metric function Fₘ( ) and error function εₘ( ) are appropriate for calculating metrics and error values for the type of metric that was used to generate metric value Zₘ.

The term α_{search}(|i|) can be added to provide a weighting so that offsets near i_{y} are preferred. To achieve this α_{search}(0) should have a zero value and α_{search}(d) should increase monotonically with increasing d. The extent of the increase will determine how great a preference will be given to offsets near the expected value of i_{y}.

Step 3: Calculate aggregate metrics χᵢ for each i offset.

$${χ}_{i} = \frac{1}{M} {\sum }_{m = 1}^{M} {β}_{i , m}$$

In one embodiment this aggregation formula could be modified to weight certain types of metric more heavily than others.
Step 4: Select the L index values i with the best aggregate metric values χᵢ. Since χᵢ is the aggregate error signal, the best result is the smallest.
Step 5: For each of the L best fit candidates, attempt to improve the result for individual metrics by considering alternative relative offsets within a small jitter range of ±Δⱼᵢₜₜₑᵣ around the video frame buffer index i_{y}+i+Δₘ. The resulting best fit metric γ_{i,m} is the value of \hat{β}i_{i,m,j} for the value of j which produces the best result. A preference for the base offset Δₘ may be imposed by adding weighting function αⱼᵢₜₜₑᵣ(|j|) which increases monotonically from a value of zero at the origin.

\hat{β}_{i,m,j}εₘ(Zₘ,Fₘ(V[i_{y}+i+Δₘ+j]))+αⱼᵢₜₜₑᵣ(|j|) for jε{−Δⱼ . . . +Δⱼ}

γ_{i,m}=(\hat{β}_{i,m,j}) for jε{−Δⱼ . . . +Δⱼ}

Step 6: The aggregate metric \hat{χ}ᵢ is recalculated from the best case value for each of the individual metrics.

$${\hat{χ}}_{i} = \frac{1}{M} {\sum }_{m = 1}^{M} {γ}_{i , m}$$

Step 7: Select the best error result value ψ based on the index i′ that minimizes the aggregate tracking error \hat{χ}ᵢ.

ψ=min(\hat{χ}ᵢ) for iε{−Δ_{S}, . . . ,+Δ_{S}}

Step 8: If the best error result ψ is below the tracking error threshold value, then the frame at offset i*=i_{y}+i′ within the frame buffer is identified as the frame corresponding to metric Z_{y} at offset k_{y} in the TV-track-stream data. Offset k_{y} becomes the new value of k* and metric Z_{y} becomes the new value of Z*. If the best error result ψ is greater than the tracking error threshold then the tracking algorithm declares a loss of tracking and must conduct a broader search in the TV track data to try to identify the passage corresponding to the frames in the frame buffer of set-top box 130.

The track following algorithm may be repeated at regular intervals to verify that the expected correspondence between forward (or backward) progress in the video data is matched by the same amount of progress through the metrics in the TV-track-stream data. In the interim between execution of the track following algorithm, the track following function assumes that progress through the metrics and their associated waymarks proceeds at the same rate as progress through the video frame data that is presented to the viewer.

In one embodiment of the invention, the seek algorithm and track following algorithm are performed as part of the track following function 541 which is implemented on system controller 420. The system controller 420 can store TV-track-stream data in memory 480 along with any Time-reference-stream data. In order to perform track following function 541, the system controller 420 may then compare the metrics calculated from frame data stored in frame memory 460 with the metrics from the TV-track-stream data stored in memory 480 in accordance with the seek and track following algorithms.

### Waymark Host Interface

Waymark host interface 550 provides information to connected clients about the progress of set-top box 130 through the video, identifying waymarks as they are encountered. Waymark host interface 550 also may provide information about the identity of the program being presented by set-top box 130 and whether the video is presented at normal speed or is halted, in reverse or fast-forward mode. This playback mode information is available to system controller 420 so it is able to provide this information to waymark host interface 550. Waymark host interface 550 can generate a stream of status information for network devices such as tablet 190. This status stream is updated at periodic intervals negotiated with the devices that it is serving, or more frequently as needed when there are changes in the video playback status on set-top box 130.

The data conveyed in the status information stream in one embodiment of the invention is described in an ASN.1 like format in Table 3. The status information stream generated by waymark host interface 550 may include Playback-mode messages, Track-id-messages, Playback-speed-messages and Tracking-messages.

TABLE 3
Playback-mode-message ::=

| | |
|---|---|
| playback-mode | ENUMERATED { |

not-active,
playback-unidentified-program,
playback-identified-program }

Track-source ::= SET {

| | | |
|---|---|---|
| host-url | IA5String | OPTIONAL, |
| host-ref | OCTET STRING | OPTIONAL } |

Track-id-message ::= SET {

| | |
|---|---|
| name-tag | IA5String, |
| id-code | OCTET STRING, |
| sources | SEQUENCE OF Track-source } |

Playback-speed-message ::= SET {

| | | |
|---|---|---|
| mode | ENUMERATED { | stopped, |
| | | normal, |
| | | unknown-trick-play, |
| | | fast-forward, |
| | | slow-motion, |
| | | reverse } , |

| | | |
|---|---|---|
| rate | INTEGER | OPTIONAL } |

Tracking-message ::= SEQUENCE OF Waymark-progression
Waymark-progression ::= SET {

| | |
|---|---|
| time-ref | INTEGER, |
| waymark-ref | Waymark-index } |

The Playback-mode-message identifies the general status of video playback at the set-top box 130. The Playback-mode values sent can indicate: i) no active playback, ii) active playback of an unknown program, or iii) active playback of an identified program. A new Playback-mode-message is sent whenever the mode changes. A Playback-mode-message may also be transmitted periodically regardless of whether the status has changed. The ASN.1 constructor ENUMERATED indicates a flag identifying one of the modes enumerated in the brackets following the word “ENUMERATED.”

The Track-id-message is used to provide the identity of the program that is being presented. There are at least three fields of information that are conveyed in this message. The first field, the name-tag, provides a text descriptor of the program if that is available. The ASN.1 type IA5String, used for this field, is suitable for ASCII compatible strings. The second field, the id-code, contains a universal ID code for the track. In one embodiment of the invention, this code should be unique to a given TV track regardless of which TV tracking server 150 provides the track. The use of a common id-code to identify multiple TV tracks, potentially from multiple different sources, indicates that the same public waymarks have been used at the same locations in the TV-track-stream for those tracks, even if other elements of the stream, such as the metrics used and the private waymarks, need not be the same. The use of the same set of public waymarks to identify the same locations in the video track allows content to be reliably associated with the video stream even if different TV-track-stream data sets are used to identify those common waymark locations. In one embodiment it is possible for different TV tracking hosts 150 to maintain different sets of tracking data having different public waymarks and metric vectors for the same video program. In that event, each unique set of public waymarks should have its own id-code. The ASN.1 data type OCTET STRING, used with the id-code field, is suitable for use with bit sequences encoded into bytes (i.e. “octets”). The third field is the sources list. This is a sequence of zero or more Track-source data structures. Each Track-source data structure includes a host-url value that identifies hosts within the wider network that can provide tracking data for the TV track identified by the id-code-field. The Track-source data also includes an optional host-ref identifier that is a key that uniquely identifies the specific TV track of interest on the server identified by the host-url value.

The Playback-speed message allows the waymark host interface 550 to indicate whether playback is proceeding at a normal speed, is stopped or is in reverse or fast forward modes. The rate value identifies the ratio between the current frame rate and normal playback rates scaled by an appropriate constant such as 240 to allow the ratio to be represented by an integer. If the video waymark host 500 on set-top box 130 does not know whether playback is stopped or proceeding backwards or forwards and at what rate. The waymark host interface 550 may indicate that playback is in an unknown-trick-play mode and not provide a rate value.

The Tracking-message is sent periodically by waymark host interface 550 and provides a list of public waymarks identified by how far they are in time from the point in the video currently being presented to the viewer. Each Waymark-progression entry in the Tracking-message identifies a number of seconds in advance of the viewer's current position in the video and the Waymark-index of the first waymark that falls immediately at or after that point in the program. For example, a Tracking-message might contain 17 Waymark-progression items. These items could identify the closest Waymark-index values that were 0, 2, 4, 6, 8, 10, 12, 14, 16, 18, 20, 30, 45, 60, 120, 300, and 600 seconds out from the current frame. If the tracking data did not extend that far the waymark host interface 550 could omit the last entries. The time progression in the Tracking-message assumes playback at a normal rate of speed. The first part of the Tracking-message that details near waypoints enables a device receiving the Tracking-message, such as tablet 190, to determine when to present data correlated to waymarks that will be encountered in the next 60 seconds. The latter part of the Tracking-message can be used to determine what waymarks may be encountered in the short term and to retrieve content associated with these waymarks from content server 160. The Tracking-message need not enumerate every Waymark-index or even every public Waymark-index that will be encountered. Because the Waymark-index values are monotonically increasing with respect to the progress of the video, the relative position of waymarks can be inferred. A target Waymark-index having a value falling between the values of two waymarks identified in adjacent Waymark-progression entries of the Tracking-message will occur sometime between the time references identified for those two adjacent Waymark-progression entries.

As discussed above, at regular intervals the track following function 541 identifies a correlation between a frame at offset i* within the video sequence available in frame memory 460 and a metric Z* at offset k* within the TV-track-stream. Track following function 541 then determines the value of Δ_{toTV}, the distance between index i* of the correlated frame and the index of the frame currently presented to monitor 110, i_{TV}.

Δ_{toTV}=i_{TV}−i*

The current position of the video, therefore, in the TV-track-stream should correspond to k*+C(Δ_{toTV}), where C( ) is the function for converting frame counts at the rate of the video program to frame counts at the rate of the TV-track-stream data. Track following function 541 can use this offset to identify public waymarks to include in a Tracking-message. If there is a public waymark within ½ second of offset k*+C(Δ_{toTV}), the closest such public waymark should be identified as the public waymark for a Waymark-progression item with a 0 second time-ref field. If the next Waymark-progression entry is for 2 seconds, then track following function 541 should identify the public waymark closest to k*+C(Δ^{toTv})+Δ_{2 secs} provided that the closest waymark is within ½ seconds on either side of this offset. Δ_{2 secs} is the number of frames equivalent to two seconds worth of video at the frame rate used in the TV-track-stream data. The public waymarks for the Waymark-progression entries for the rest of the Tracking-message may be derived in the same manner.

The time progression used in the Tracking-message and the frequency with which the waymark host interface 550 transmits new Tracking-messages can be negotiated between set-top box 130 and tablet 190. The messages required for a negotiation of session data parameters such as these are common in the art and are not detailed in Table 3.

Waymark host interface 550 may be implemented on system controller 420. System controller 420 can arrange the status information generated by track following function 541 into data packets for transmission across the LAN to tablet 190. System controller 420 can then transfer the data to one of wired network interface 491 or wireless network interface 492 to transfer the date to the LAN and from there to tablet 190. In the arrangement shown in FIG. 1, tablet 190 connects to the LAN through a wireless access point hosted on network router 170 to which set-top box 130 is connected by a wired interface. In this configuration, waymark host interface 550 would transmit waypoint data to tablet 190 via wired network interface 491 to network router 170 and from there via the wireless access point of network router 170 to tablet 190.

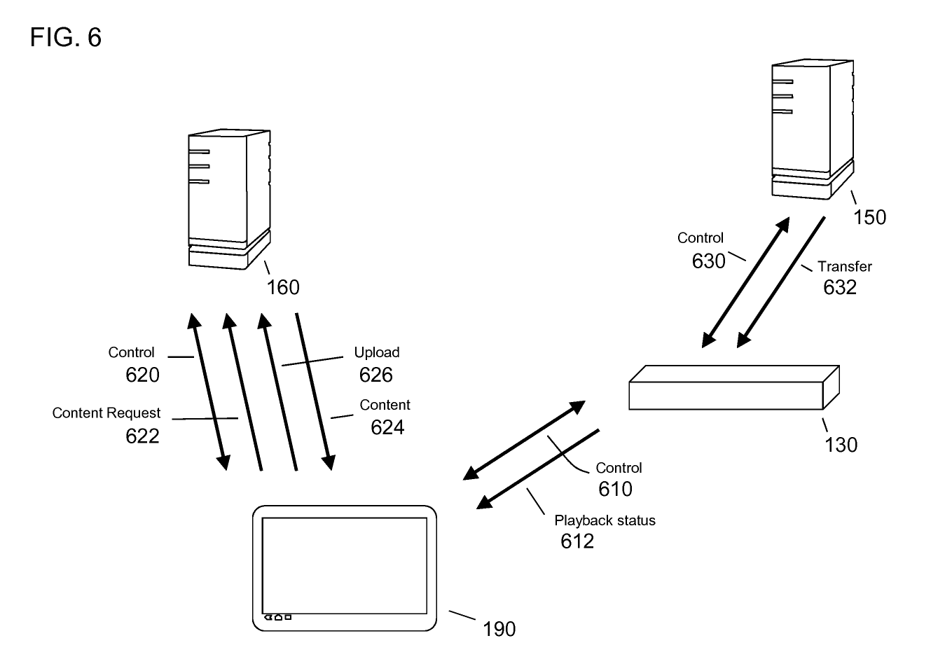

FIG. 6 provides an illustration of the types of data flows that may take place in accordance with one embodiment of the invention between content server 160, tablet 190, set-top box 130 and TV track server 150 when the user of a TV interaction system like that shown in FIG. 1 is watching a video program. In order for tablet 190 to present content linked to a video program to the user, the waymark service control function 222 on tablet 190 must first determine whether it can access a TV track host 500 and also whether tablet 190 is in a physical location where the user of tablet 190 has access to TV monitor 110 such that they might wish to receive information about content associated with the video program on it.

When the tablet 190 is turned on, the waymark service 220 will determine whether it can communicate with a video waymark host 500 on a device such as set-top box 130 in order to set up a TV track session. The user of tablet 190 may configure the waymark service 220 on tablet 190 with the network address where set-top box 130 may be found on the user's LAN. When the waymark service 220 discovers, via network functions 214, that tablet 190 is connected to the user's LAN, the waymark service 220 can then send a TV track session request directly to this address. Network addresses for other video waymark hosts 500 can also be entered for other LANs that the user may also have access to.

Alternatively, the waymark service 220 can attempt to discover the presence of video waymark hosts 500 by broadcasting on the LAN a packet requesting that video waymark hosts identify themselves. This ID request packet is directed to a host port number associated with the TV track service. The use of broadcast packets directed to service specific ports is common to many networked applications and is familiar to persons of ordinary skill in the art. If video waymark hosts 500 are connected to a LAN in which an ID request is sent, the waymark host interface 550 will respond with messages identifying the video waymark host 500 and providing its network address to the originating tablet 190, so that tablet 190 can then request commencement of a TV track session. The responsive message may also indicate whether set-top box 130 is actively supplying video programming to a monitor 110.

When the waymark service 220 has identified one or more video waymark hosts 500 either at preprogrammed stored addresses or in responses to a broadcast request for identification, the waymark service control function 222 can then attempt to initiate a data session with one of the video waymark hosts 500 that it has identified using requests conveyed as part of control flows 610. Waymark service control function 222 may prefer first to communicate with video waymark hosts 500 that are actively providing video programming.

### Data Flows Between Tablet and Set-Top Box

Control flows 610 between tablet 190 and set-top box 130 are illustrated in FIG. 6. A TV track session may be created between tablet 190 and the video waymark host 500 in set-top box 130 upon request. Waymark service control function 222 transmits a request to waymark host interface 550. The request identifies the tablet 190 and the network address and port that should be used to communicate with waymark service 220.

Provided that set-top box 130 has the available resources to support a new TV track session, video waymark host 500 will usually accept a session in a response transmission to waymark service 220. In addition, video waymark host 500 may provide some or all of Playback-mode-message, Track-id-message and Playback-speed-message data as described in Table 3, indicating whether it is actively providing video programming to monitor 110 and providing identification information for that programming.

Each TV track session between a video waymark host 500 and a connected device such as tablet 190 is identified by a unique identifier value provided by video waymark host 500 when it grants a request for a TV track session and can be terminated by a terminating message from either of waymark service control 222 or waymark host interface 550.

If programming is being presented on monitor 110, the waymark service 220 must determine whether tablet 190 is in the general vicinity of monitor 110 so that the user of the tablet might wish to receive content associated with the video programming presented on monitor 110.

One method to determine this is for the waymark service control function 222 to notify the user of the tablet 190 that the TV track service is available and inquire as to whether the user would like to receive information about content associated with the video being presented on monitor 110.

Another method does not require querying the user, but assumes that if the user is in the same general vicinity as the TV monitor 110, they should be notified of the existence of content associated with video programming on the monitor. The waymark service control function 222 may use several techniques to determine whether the tablet 190 is in the general vicinity of the TV monitor 110. If the wireless network device is used to connect tablet 190 to the network and the wireless base station is known to be collocated with the TV monitor 110, the signal strength of the received wireless signal may be used by tablet 190 as a measure of proximity to the TV monitor 110. Alternatively, if tablet 190 includes a microphone, the waymark service control function 222 can sample the detected audio signal. The waymark service control function 222 may transmit these recorded audio samples to the waymark host interface 550 and request that the video waymark host 500 compare the audio sample recorded by tablet 190 with the audio signal sent by set-top box 130 to monitor 110. If the audio signal recorded by the tablet 190 includes the audio from the TV monitor 110, the video waymark host 500 indicates this match to tablet 190, which then may conclude that tablet 190 is located near TV monitor 110.

In an alternate embodiment, tablet 190 may request that video waymark host 500 transmit an audio signal sample, or some characteristic data derived from the audio signal, to waymark service 220 which can then make its own comparison of the audio signals.

Once a session has been set up, tablet 190 may transmit session configuration information as part of the control flows 610. In one embodiment of the invention the default behavior of waymark host interface 550 is to transmit a Tracking-message every 15 seconds with entries identifying Waymark-index values at 0, 2, 4, 6, 10, 12, 14, 16, 18, 20, 30, 45, 60, 120, 300 and 600 seconds from the current video position. Tablet 190 can send a configuration message requesting a different set of time sampling points in the Tracking-message and a different transmission interval.

Program status flows 612 are illustrated in FIG. 6 flowing from set-top box 130 to tablet 190. Once a TV track session is established between set-top box 130 and tablet 190, waymark service control 222 may request that the video waymark host 500 commence a flow of program status data to tablet 190. In response to this request, the waymark host interface 550 begins to supply a stream of status of information to TV track service 220 through program status flows 612. In one embodiment of the invention, program status flows 612 have the format of the Playback-mode-message, Track-id-message, Playback-speed message and Tracking-message identified in Table 3 and discussed above. When these messages are transmitted from the waymark host interface 550 they are sent in packets that include header information identifying the unique TV track session identifier assigned by the waymark host at session creation. The use of a session identifier allows tablet 190 to distinguish between multiple program status flows 612 originating from one or perhaps multiple different video waymark hosts. This could be important if there are multiple programs being presented simultaneously on two different collocated monitors or where more than one program is being presented on a single screen.

Data Flows between Tablet and Content Server

Tablet 190 may create a data session with content server 160 before there is any TV track session between tablet 190 and set-top box 130. If the content server 160 hosts a social networking site, for example, the user of tablet 190 may access the site to view data posted by “friends” and other members of the social groups which the user has joined.

The particular messages required for accessing a content server 160 will depend upon the design of that application. These communications are depicted in FIG. 6 as control flow 620. In general tablet 190 will request formation of a secure connection between itself and content server 160. Tablet 190 may be required to provide authentication to prove that it is entitled to access a particular account on content server 160.

Once a TV track session is established between waymark service 220 and video waymark host 500, the existence of this session, along with any program identification information from Track-id-messages received as part of the playback status flows 612 is available to social network application 231 through waymark update function 221. Depending upon the configuration of the interface between them, waymark service 220 may provide automatic notification to social network 231 whenever a TV track session is established or when a new program is identified as being played back on monitor 110. Alternatively, social network application 231 may obtain this information by querying waymark update function 221 for it.

When social network application 231 learns of a new TV track session it may request formation of a data session between tablet 190 and content server 160 if one does not already exist. Once a session is formed the tablet 190 and content server 160 may use content request flows 622 and content flows 624 to provide content related to the video program playing on monitor 110 to tablet 190.

The format for some of the messages in content request flows 622 and content flows 624 in accordance with one embodiment of the invention is illustrated in Table 4.

TABLE 4
Content-window-request ::=SET {

| Id-code | OCTET STRING | OPTIONAL, |
|---|---|---|
| sources | SEQUENCE OF Track-source OPTIONAL, | |
| base-waymark | Waymark, | |
| window-size | Time-reference | OPTIONAL, |
| max-transfer | INTEGER | OPTIONAL } |

Content-window ::=SEQUENCE OF {

| start-position Position-reference, | | |
|---|---|---|
| description | Descriptor-type, | |
| end-position | Position-reference OPTIONAL, | |
| lifetime | INTEGER | OPTIONAL, |
| content | Content-item } | |

Content-item ::= CHOICE {

| | |
|---|---|
| content-ref | OCTET STRING, |
| content-data | <content data structure> } |

Descriptor-type ::=SET {

| | | |
|---|---|---|
| short | IA5String | OPTIONAL, |
| long | IA5String | OPTIONAL, |
| author | IA5String | OPTIONAL, |

| | |
|---|---|
| thumbnail | <image data> OPTIONAL } |

Content-request ::=SEQUENCE OF {

| | |
|---|---|
| content-ref | OCTET STRING } |

Content-transfer ::=SEQUENCE OF SET {

| | |
|---|---|
| content-ref | OCTET STRING, |
| content-data | <content data structure> } |

Content-creation-request ::=SET {

| | | |
|---|---|---|
| id-code | OCTET STRING | OPTIONAL, |
| position | Position-reference, | |
| lifetime | INTEGER | OPTIONAL, |
| description | Descriptor-type, | |

| | |
|---|---|
| content-data | <content data structure> } |

The social network application 231 transmits Content-window-request messages as part of content request flow 622 to content server 160 when the viewed program changes. In this situation the new id-code for the track must be supplied to content server 160 from the information received from set-top box 130 in the Track-id-message. The social network application 231 may also provide the Track-source information supplied by the set-top box 130. If the id-code for the track is not specified, the content server 160 assumes that the program has not changed from the last id-code value presented.

The Content-window-request message includes a base-waymark value that specifies a Waymark-index that defines the starting point for a requested transfer of content from content server 160. The Content-window-request may also specify a window-size, defined in frames or seconds, as well as a max-transfer size. The content server 160 responds to the Content-window-request by determining whether it has content associated with the specified track-id that is accessible to the user. If so, then content server 160 determines what part of that content may be linked to waymarks that fall within the window defined by the base-waymark and window-size fields. The content server 160 then transmits Content-window messages as part of content flows 624 to transfer information about content linked to frames within the playback window starting at the base-waymark and extending for the amount of time specified by the window-size field. If the content information for the specified window exceeds the specified max-transfer size, which can be specified in kilobytes, the content server 160 will transfer only as much of the content information associated with the beginning of the waymark window as fits within the max-transfer size. If max-transfer and window-size are not specified the content server uses default values.

The Content-window message consists of a series of zero or more sets of content data, each including a start-location field identifying the point in the sequence of waymarks to which the content is associated, a description, and a Content-item object. In addition the data may include two fields that characterize the duration of the relevance of the content. The first such field is the end-location field which identifies a point in the waymark sequence which may be thought of as the end of the passage of the video to which the content is relevant. The second field is the lifetime value which identifies in seconds how long the content should be presented to the user of the TV interaction system. The Descriptor-type may include short and/or long descriptions of the content, the identification of the author of the content and, in some contexts, a thumbnail icon to display as part of the representation of the content. The format for the thumbnail image will depend upon the particulars of the social network application 231. Typically the thumbnail data would employ a standard container format that allows the thumbnail to be represented in one of a variety of image formats such as JPEG or PNG.

The end-location field and the lifetime field serve similar purposes and indeed if the video is viewed at normal speed and the content is presented to the user as soon as the starting waymark is reached either the end-location field or the lifetime field could be used to identify when the content should be withdrawn. Content server 160 may allow providers of content to either or both of these values in addition to the start-location reference point when they add content. In the social network data structures illustrated in FIG. 3 the start-location data is contained in the locator 351 and either or both of the end-location and lifetime data are stored in duration 352. The social network may also impose a minimum and maximum lifetime value. In that case the social network application 231 can be designed to give priority to the lifetime value over the end-location.

The content server 160 may send the data that comprises the content if that content is relatively compact, such as a short piece of text. If the content is more lengthy, the content server 160 may only transmit a content-ref field that serves as a unique identifier that can be used later to retrieve the content. The possibility of either of these options is reflected in the Content-item data type, which can either include a content-ref value or the content data. The format for the detailed content data is not specified in Table 4. Because the content can take many different formats, it may be desirable to wrap the data in a container format that allows different types of content to be identified so that content of different types can be identified and correctly decoded and presented to the user. If the content is compact so that the Content-item includes the actual content, rather than a reference, the social network application 231 may present all of the content to the user of tablet 190 when the appropriate playback position is reached. If the content is more bulky and the Content-item contains only a content-ref, the social network application 231 may present one of the descriptions provided as part of the Descriptor-type data to the user at the appropriate point. If the user of tablet 190 demonstrates interest in the content based on the Descriptor-type data, the social network application 231 can transmit a Content-request message that includes the content-ref value for the requested content. The content-request message is carried as part of the request flow 622 to content server 160. If able, the content server 160 will respond by transferring the actual content in a subsequent Content-transfer message as part of the content flow 624. The Content-transfer message consists of a series of content-ref values corresponding to references requested by the social network application 231 accompanied by the associated content. The actual format for the content in the Content-transfer message is not specified in Table 4 as it will depend heavily upon the types of content that the social network application 231 is designed to present. As discussed above, it may be desirable to use a standard wrapper format to transmit the content data.

The user of tablet 190 may also wish to generate their own content linked to video program playback and to post this to the social network. In one embodiment, the social network application 231 allows users to tag a point during playback of the video program. The social network application then stores a Position-reference data structure that identifies the nearest public waymark and the offset from that waymark to the frame tagged by the user. The user can then prepare content such as written text commenting on that point in the video. When the user has completed the content they can request that the content be made available on the content server 160 at the tagged frame. The user also provides a description of the content and a lifetime defining the length of its relevance to viewers to social network applications 231. The social network application 231 then constructs a Content-creation-request message as defined in Table 4. The Content-creation-message includes the stored Position-reference data and the content-data provided by the user as well as a lifetime value specifying for how long the content remains relevant if that has been identified by the user, a description of the content and the content data itself. The Content-creation-request message may also include an id-code identifying the track to which the content is to be associated. If this data is not provided the content server 160 may assume that the id-code used within the last Content-window-request is to be used. Content server 160 responds to the Content-creation-request message by storing the new content in a content structure 350 in a set of user content 340 associated with a program identifier 331 containing the id-code for this track.

Data Flows between Set-top Box and TV Track Server

In order for the video waymark host 500 or set-top box 130 to provide waymark service, it must retrieve TV-track-stream data for the video program being presented. The set-top box 130 usually has access to identifying information about a video program. For a traditional television program the set-top box will know the time the program was broadcast and the television channel it was received on. It may also have other bibliographical information such as the name of the show and identifying information about the episode. If the video program was transmitted on demand the set-top box 130 will have access to the title and other identifying information that was presented to the user when they chose to download the program as well as whatever identifying information is provided by the server that sources the programming.

When the user directs set-top box 130 to present a video to monitor 110, the set-top box 130 attempts to retrieve TV-track-stream data for that program from a TV track server 150. The set-top box 130 first must determine whether any TV track servers 150 that it may access have TV-track-stream data for this program. It can do this by transmitting inquiries to these TV track servers 150 providing the bibliographic data that it has for the program and requesting confirmation as to whether servers have TV-track-streams for programs that match this data. If a TV track server 150 does have a track it responds by providing one or more id codes for that track. As described above in connection with Table 3, the id-code is a key that uniquely identifies a family of TV-track-stream datasets that provide the same set of public waymarks for a particular video program. The TV track server 150 may also provide a host-ref for the track that serves as a specific identifier for that track on that specific TV track server 150.

In one embodiment of the invention the program guide that provides video program scheduling and description information to the set-top box 130 may include id-codes for associated TV-track-streams and may also provide Track-source-data, as detailed in Table 3, that identifies TV track servers 150 from which the TV-track-stream data can be obtained, and possibly host-ref values as well.

Inquiries from set-top box 130 to TV track server 150 regarding hosting of TV-track-stream data and the resulting responses from TV track server 150 are contained within control flows 630 in FIG. 6. Once the set-top box 130 has identified a TV track server 150 that can source a TV-track-stream for the program it is presenting it can request transfer of the stream as part of control flow 630. In one embodiment of the invention the request could have the form of the Track-data-request in Table 5.

TABLE 5

Track-data-request ::=SET {

CHOICE {

| | |
|---|---|
| track-id | OCTET STRING, |
| host-ref | OCTET STRING }, |

| continue-flag BOOLEAN, | | |
|---|---|---|
| offset | Distance-measure | OPTIONAL, |
| max-length | Time-reference | OPTIONAL, |
| max-transfer | INTEGER | OPTIONAL, |

| | |
|---|---|
| transmit-time-references | BOOLEAN } |

In the Track-data-request the set-top box 130 identifies the requested TV track by one of track-id or host-ref. The set-top box 130 may specify what portion of the TV-track-stream it wishes to receive in one of two ways. It may set a continue-flag to indicate that the TV track server 150 should transmit the next part of the TV-track-stream that follows directly after the portion that it last transmitted. Alternatively, set-top box 130 may provide an offset value indicating how far into the video program the requested TV-track-stream should begin. If no offset is specified and the continue-flag is not set the TV track server 150 will provide data from the beginning of the TV track. The set-top box 130 may also specify limits on the amount of TV-track-stream data that is to be transferred, specifying either or both of a maximum number of frames or seconds of video that the TV-track-stream data should encompass and a maximum data transfer size. Finally the set-top box 130 may also indicate whether it wishes to receive a Time-reference-stream associated with the TV-track-stream if this is available.

In response to this request the TV track server 150 will provide TV-track-stream data, depicted in FIG. 6 as transfer flows 632. When the tracking algorithm in set-top box 130 approaches the end of the portion of the video program covered by the TV-track-stream data that it has already downloaded track following function 541 will request additional TV-track-stream data using follow on Track-data-request messages.

System controller 420 conducts the interactions with TV track server 150 that make up control flow 630 and receives the TV-track-stream data carried in transfer flow 632. When TV-track-stream and Time-reference-stream data are received by set-top box 130 they can be stored in memory 480 or non-volatile storage 485.

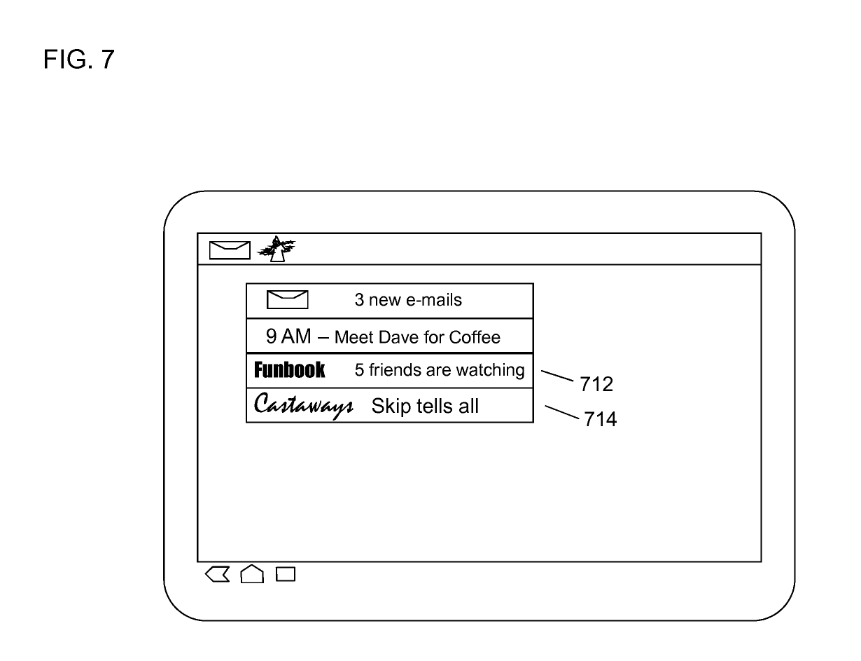

FIG. 7 illustrates an example of information that may be displayed on tablet 190 when it is being used in connection with the invented TV interaction system. In FIG. 7 the user of the tablet has expanded a notification window of the tablet operating system, which is visible on the display. The notifications window includes notification items from an email and calendar applications as well as a social network notification 712 and a notification 714 provided by a video content search application.

The social network notification 712 is of a type that might be generated by a social network application 231. As discussed previously, the social network application 231 on tablet 190 communicates with a content server 160 hosting a social network to determine whether the user of tablet 190 has access to content related to a currently viewed video hosted on content server 160. Because users of the social network can share what video programming they are watching with the social network and the network can track this information with TV track status data 314 in a user's profile, the social network application 231 can identify that friends of the user are also watching the video program that the user is watching. In FIG. 7, the social network application 231 has generated a notification 712 indicating that some of the user's friends are also watching the video program and that there is related content available for viewing. Depending on the operating system used in tablet 190, the user may be able to launch social network application 231 by selecting notification 712.

Tablet 190 can also host applications such as content searcher 232. As described previously, content searcher application 232 searches for content related to the current video program from a variety of public sources that may be selected by the user. In the scenario illustrated in FIG. 7, the user is watching a reality show called “Castaways” about survival on a tropical island. In one possible usage scenario the producers of the show have made additional program-related content available for retrieval from a public server. Some of this content is linked to particular passages of the program. In the example illustrated in FIG. 7, the content searcher 232 has identified a piece of “Castaways”-related video in which a character on the show named “Skip” provides a more detailed explanation of the motives behind his behavior on the video program. The content searcher 232 has provided a notification item 714 alerting the user of tablet 190 to the availability of this content. If the user selects this notification item the identified video can be retrieved from a server and presented.

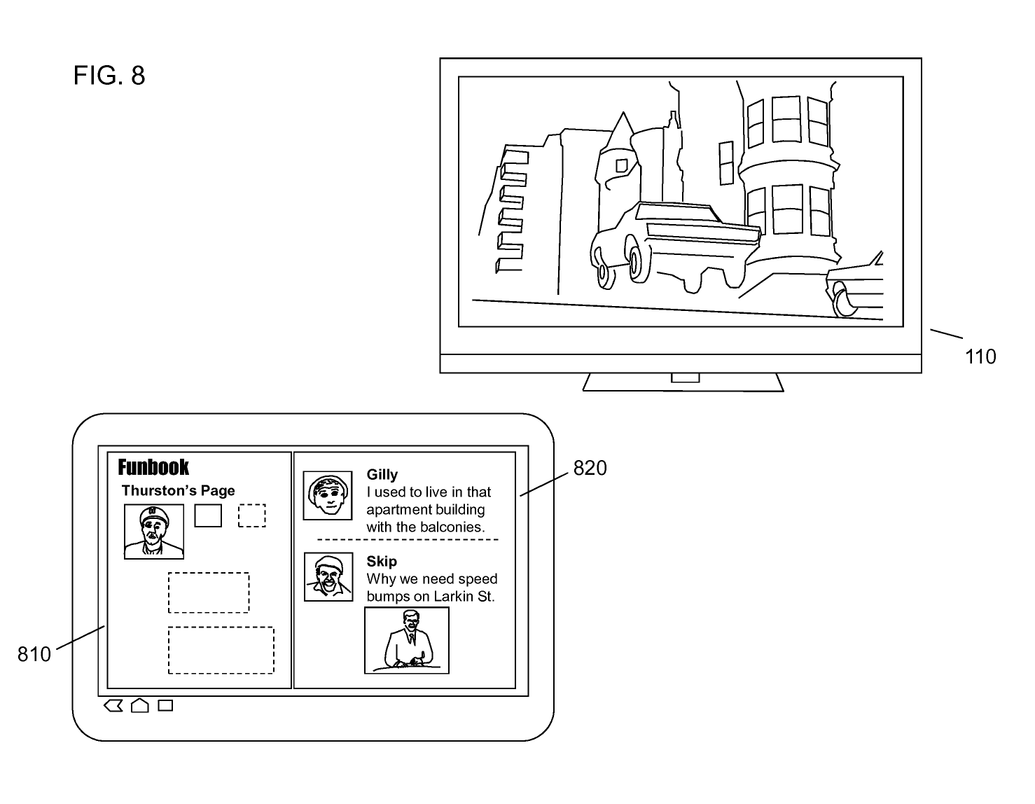

FIG. 8 illustrates another example of one possible mode of usage of the invented TV interaction system. A user is watching a movie featuring a car chase through an urban setting on monitor 110. Simultaneously they are using a social network application 231 on their tablet 190. The social network application 231 includes the capability to view a user's home page and other content posted by the user's friends. This material 810 is displayed on tablet 190. In addition, when social network application 231 is alerted that a TV track session is available, in one embodiment it may open an additional window 820 to display content associated with the current video program to which the user has access. In FIG. 8 this content includes commentary from the user's friends “Gilly” and “Skip” related to the particular passage of the video program that the user is viewing. Skip has posted text and a video segment relating to the action on the TV show.

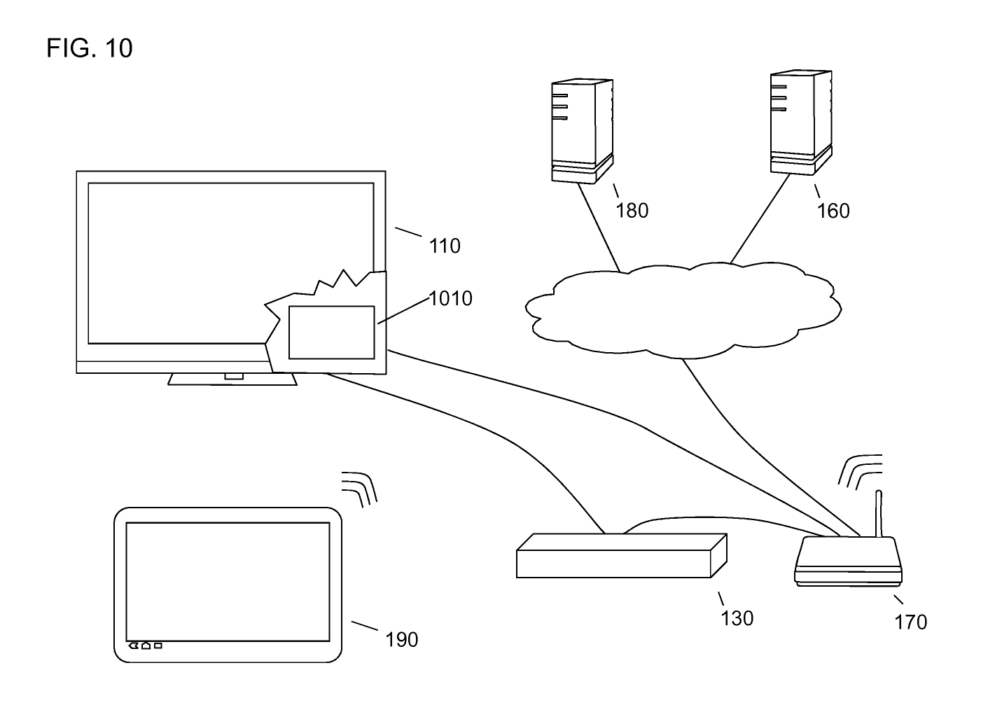

FIG. 10 illustrates an alternative embodiment of the invention in which video programming content is provided from a video content host 180 that may be connected to monitor 110 or set-top box 130 through a public network such as the internet.

In FIG. 10 the monitor 110, set-top box 130, content server 160 and network router 170 are similar to the devices described in connection with FIG. 1. Monitor 110 may have a LAN connection of its own and may, therefore, be connected to the LAN, perhaps, as shown in FIG. 10, through the network router 170. Video content host 180 provides video programming such as movies and television shows to client applications on demand through the public network. Monitor 110 and set-top box 130 may include video content client applications that allow them to receive video programming sourced from video content host 180 by way of the LAN and wide area network or internet, illustrated by the cloud in FIG. 10. If the video content client application is located on monitor 110 the resulting programming may be displayed directly on monitor 110. If the video content client application is located on set-top box 130 the video programming from content host 160 must be decoded and then converted to a format appropriate for transmission to the attached monitor 110. Typically the format used is HDMI since this provides for secured transport of the programming to monitor 110. The type of video content hosting illustrated in FIG. 10 is widely deployed. Examples of this type of video content hosting service are offered today by services such as Vudu, Blockbuster.com, Amazon.com and others. Client applications for one or more of these services can be found in most modern digital television sets as well as Blu-Ray players and many stand-alone set-top devices such as Google TV enabled devices, the Boxee box, and others.

The video programming sourced from video content host 180 is typically encoded in a format such as H.264/MPEG-4 AVC. This has the advantage that the content is encoded efficiently and in a manner that enables transport across a packet based network such as the internet and a user's Ethernet LAN. The video programming is usually encrypted to prevent piracy of the video content. In order to present this video content, monitor 110 or set-top box 130 may include a video decoder for decoding video from the format used by video content host 180. In set-top box 110 this decoding can be achieved using the video and audio codecs 430 illustrated in FIG. 4.

In the embodiment illustrated in FIG. 10, an alternative TV track host 1010 is shown inside monitor 110, which is depicted in a cut-away view. In this embodiment alternative TV track host 1010 is implemented on a processor which has access to memories and non-volatile storage for storing data received from the TV track service elements depicted in FIG. 10. The alternative TV track host 1010 has access to the network interfaces of monitor 110 and can initiate and receive communications with content server 160 and video content host 180. The location of the alternative TV track host 1010 internal to monitor 110 is appropriate for scenarios where video content host 180 transmits video content directly to monitor 110. In the alternative embodiment in which video content host 180 transmits encoded video content to set-top box 130 for decoding, the alternative TV track host 1010 may be located on set-top box 130. In the discussion that follows we will assume that alternative TV track host 1010 is located in monitor 110 but it will be understood that it could just as readily be located in set-top box 130 without substantially altering its character. Regardless of whether it is located in monitor 110 or set-top box 130, alternative TV track host 1010 may participate in control flows 610 with tablet 190 like those discussed in connection with FIG. 6. In addition, alternative TV track host 1010 receives alternative waymark streams from video content host 180 that allow it to generate playback status flows 612 like those of FIG. 6.

Unlike TV track host 500, illustrated in FIG. 5, the alternative TV track host 1010 does not determine the video playback position and identify waymarks by calculating metrics derived from the video content. Instead, video content host 180 provides an alternative waymark reference stream that allows alternative TV track host 1010 to determine current waymarks. The content of the alternative waymark reference stream in accordance with one embodiment of the invention is identified in Table 6.

TABLE 6
Alt-waymark-block ::= SET {

| | |
|---|---|
| video-seq-id | OCTET STRING, |
| waymark-list | SEQUENCE OF Alt-waymark-entry, |
| sequence-length | Distance-measure } |

Alt-waymark-entry ::= SET {

| | |
|---|---|
| waymark-ref | Waymark-index, |
| position | Distance-measure } |

Video content host 180 provides video data to monitor 110 in coded sequences of video frames. Each of these sequences is identified by a sequence ID. Associated with each encoded video sequence is an Alt-waymark-block. The Alt-waymark-block includes a video-sequence-id field that takes on the value of the video sequence ID of the sequence that the Alt-waymark-block is associated with. It also includes a waymark-list that identifies each public waymark that would be encountered during playback of the video sequence and the distance, in frames or time, from the start of the video sequence to that particular waymark. Finally, the Alt-waymark-block includes a sequence-length field that identifies the total length of the video sequence.

The Alt-waymark-blocks can be transferred by video content host 180 to monitor 110 independently of the associated video sequences. As a result the alternative TV track host 1010 can read multiple Alt-waymark-blocks forward from the current playback position so that it can determine what public waymarks lie ahead not only in the current video sequence but in video sequences minutes ahead of the current playback position. As monitor 110 generates and presents frames from a particular video sequence it counts frames in the sequence, or monitors picture count values contained in the video sequence data, to determine how far into the video sequence the current playback position of the video program is located. Alternative TV track host 1010 uses this count of the number of frames to define an offset into the waymark-list data structure contained within the Alt-waymark-block object associated with the current video sequence. The Alternative TV track host 1010 can then determine what public waymarks are forthcoming and how far forward from the current playback position they are located. The alternative TV track host 1010 can then use this information to prepare a Waymark-progression data structure, as defined in Table 3, for transmission to tablet 190. If the waymarks identified in the waymark-list data structure do not extend far enough into the future to identify waymarks for some of the more distant time points in the Waymark-progression, the Alternative TV track host 1010 can use data from subsequent waymark-lists to fully populate the Waymark-progression data. The ordering of waymark-list data structures can be determined with reference to the data, not shown in Table 6, that is supplied with the encoded video sequences and identifies the order of these sequences based on their video-seq-id values.

Because the video content host 180 supplies all of the information required to calculate public waypoints along with the encoded video data, the alternative TV track host 1010 does not need to receive any TV-track-stream data from TV track guide server 150.

### Live TV

With regard to the alternative embodiment of FIG. 10, in which Waymark-index information is provided with the video content, it makes little or no difference whether the video program is a transmission of a live event or a retransmission of a recorded program. The TV tracking host 1010 receives the waymarks at the same time as it receives the video programming and is able to present any content associated with those waymarks. If the video programming is of a live event there may not be any content associated with a waymark at the time the identified video passage is received and presented on the TV monitor. Users of the TV tracking system may create associated content and associate it with recently passed waymarks. Applications receiving waypoint information from the TV track service 220, such as social network application 231 and content searcher application 232, must keep track of past waymarks and when they were encountered so that content that is added to content server 160 during presentation of the live video program and associated with a waymark fixed to a portion of the video program that has already been displayed can be presented to the viewer if the lifetime defined for the content has not yet expired.

When the video programming is not of a live event but is the first transmission of a recorded program, the producer of the program can prepare a set of waymarks for the program and associated content in advance of the transmission. These waymarks can be presented in the manner of an alternative waymark stream transmitted with the video programming as described in connection with FIG. 10. The producers of the video program can also produce a waymark stream containing video metrics as illustrated and discussed in connection with FIG. 9. With a prepared waymark stream that is available before or at the time of first broadcast of the program the operation of the TV tracking system is largely the same as it would be during a subsequent viewing. There may, however, be less viewer-generated content associated with the video program at the time that it is first presented.

The situation is slightly more complicated when the system is used during a live first broadcast for which no waymark stream yet exists. If TV track server 160 is generating a waymark stream for the video program in real-time there may be a delay between when a specific video frame is presented on monitor 110 and when the tracking information for a waymark associated with that frame is received from TV track server 160 by video waymark host 500.

In one embodiment of the invention the TV track server 160 may indicate as part of control flows 630 that the tracking information that it provides is being generated from a first broadcast. Given that indication the video waymark host 500 may have to delay the tracking function so that one set of frames is presented to the viewer on monitor 110 while a different, earlier set of frames is used for tracking. In this scenario it is possible that by the time the latest metric and waypoint information is received from TV track server 160 the frames from which these metrics could be calculated will have already been presented to the viewer and may have been evicted from the frame memory 460 in set-top box 130. One possible method of calculating the metrics is to store a rolling window of past frames, perhaps in encoded form, in memory 480 or non-volatile storage 485. These frames can then be retrieved and decoded when needed in order to generate metrics for comparison with the metrics in the received tracking data. This, however, has the disadvantage that it requires a second decoding of the video stream. An alternative tracking method is to generate a set of metrics for frames or a subset of frames as they are received and presented to the viewer and to store these metrics in memory 480 or non-volatile storage 485. These stored metrics can later be retrieved by system controller 420 for comparison with the received metrics contained in TV-track-stream data received from TV track server 160.

In this mode of operation the frames whose metrics are being matched to the TV track by the track following module 541 necessarily fall behind the video frames being presented on monitor 110. The track following module 541 must keep track of the Δ_{toTV} value that identifies the distance between the currently viewed frames and the last frames successfully matched to metrics from TV track server 160. Provided that the size of this delay is sufficiently limited the track following module 541 may still be able to provide useful tracking information. If the size of Δ_{toTV} exceeds a maximum threshold the track following function 541 should declare loss of tracking and update the tracking status flows 612 accordingly.

If TV track server 160 is identifying waymarks only after the corresponding or nearby video frames have been displayed on monitor 110 the waymark host interface 550 will be unable to provide Waymark-progression data that projects into future frames. Instead the Waymark-progression would be limited to entries with negative time-ref values, i.e. identification of waymarks that were reached in the past. The most recent waymarks that can be identified in this situation will be the ones most recently received from tracking server 160. If the latest waymark is Wₗₐₛₜ which falls at offset kₗₐₛₜ, the offset of this waymark in frames from the current playback position will be C(Δ_{toTV})+(kₗₐₛₜ−k_{y}), where k_{y} refers to the offset of the metric last correlated to a frame in the frame buffer. In order to construct a Waymark-progression for waymark Wₗₐₛₜ the track following function 541 would convert the frame count C(Δ_{toTV})+(kₗₐₛₜ−k_{y}) to a time offset by dividing it by the frame rate of the TV-track-stream data. The time-ref values for earlier waymarks could be calculated in a similar manner. For example, to identify a public waymark 2 seconds prior to Wₗₐₛₜ, find the closest public waymark that is within ½ second of C(Δ_{toTV})+(kₗₐₛₜ−k_{y})−Δ_{2 secs} where ×_{2 secs} is the number of frames in a two second interval at the video frame rate. The track following function 541 can also calculate time-ref values for earlier waymarks using the Time-reference-stream information if that is supplied by TV track server 160.

The negative time-ref values can be used by application programs 230 to identify the range of public waymark values that were reached in the recent past. If content retrieved by application programs 230 such as social network 231 has a lifetime indicated the application program can compare that lifetime to negative time-ref value associated with the nearest waymark to determine if the life of that content extends beyond the current viewing position. If so the application program 230 may present the content to the user.

### DVR Mode

With reference to FIGS. 4 and 5, track following function 541 may be implemented on system controller 420 and can be used to associate waymarks with video data when it is recorded by a set-top box 130 operating in DVR mode. A digital video recorder (DVR) receives video data which it may transcode and then stores this video data for presentation at a later time. In FIG. 4 the DVR function is achieved by receiving video data at tuner/DVR block 410. If transcoding is required the data is provided to video and audio codecs 430. Then the encoded video and audio data is stored in non-volatile storage 485. When the user of set-top box 130 requests to view the program the encoded data is retrieved from non-volatile storage 485 and provided to video and audio codecs 430 for decoding. The resulting data is placed in frame memory 460 for transfer to monitor 110.

In one embodiment of the invention, set-top box 130 can determine the correspondence between video frames and public waymarks at the time the video is stored by the DVR. In order to achieve this, video data is decoded at the time it is first received by video and audio codecs 430. The resulting decoded frame data is placed in frame memory 460 where track following function 541 implemented on video controller 440 can determine the correspondence between video frames and waymarks from TV-track-stream data. The video controller 460 can store data correlating public waymarks to specific frames within the encoded video data stored by the DVR. This correlating data can be stored with the encoded video data in non-volatile storage 485. When the program is retrieved for presentation the data identifying the correspondences with TV-track-stream waymarks may also be retrieved and used by track following function 541 and waymark host interface 550 to determine the public waymarks to identify in Tracking-messages.

The manner in which the correlation between encoded video and waymarks is represented and stored will depend upon the format of the encoded video data. If there is provision in the coded data format for identifying specific sequences of video the correspondence data can associate waymarks with the identifiers for a particular sequence of video plus a count of the number of frames into the sequence where the frame associated with a specific waymark is to be found. If the coding format does not provide a built-in method of identifying sequences or frames, the set-top box 130 can generate its own frame index by counting the frames as they are decoded.

Whether set-top box 130 performs track matching and track following functions when the video data is received or when it is presented, or perhaps both with different parts of a program, may depend upon the processing load required of the set-top box 130 at any particular time. In certain situations it may be advantageous for the DVR function to store coded video and then at a later time retrieve it and perform track matching and track following before any request has been made to view the program.

Many modifications and variations of the TV interaction system are possible. In view of the detailed description and drawings provided of the present invention, these modifications and variations will be apparent to those of ordinary skill in the art. These modifications and variations can be made without departing from the spirit and scope of the present invention.

What is claimed is:

1. An apparatus for enabling user interaction with media content, comprising:
a video metric engine that calculates metrics derived from media presented for display;
a network interface to retrieve tracking data containing a sequence of metrics related to a position within a media program;
a track matching engine that correlates a sequence of the calculated metrics provided by the video metric engine with the retrieved tracking data, and, based on the correlation, identifies one of the positions identified within the tracking data as the current position of the media presented for display; and
a wireless communication circuit to transmit the current position.
